(19) United States
(12) Patent Application Publication
(10) Pub. No.: US 2026/0113102 A1
(43) Pub. Date: Apr. 23, 2026

(54) SYSTEM PROVIDED WITH WIDE-AREA CELL BASE STATION AND TERRESTRIAL-CELL BASE STATION

(71) Applicant: SoftBank Corp., Tokyo (JP)

(72) Inventors: Tsutomu Ishikawa, Tokyo (JP); Koji Tashiro, Tokyo (JP); Kenji Hoshino, Tokyo (JP); Atsushi Nagate, Tokyo (JP)

(73) Assignee: SoftBank Corp., Tokyo (JP)

(21) Appl. No.: 19/168,710

(22) PCT Filed: Mar. 12, 2024
(86) PCT No.: PCT/JP2024/009624

§ 371 Date: Sep. 24, 2025

(30) Foreign Application Priority Data
Mar. 29, 2023 (JP) 2023-053899

(51) Int. Cl. H04B 7/185; H01Q 3/26; H04W 72/0446; H04W 72/0453

(52) U.S. Cl. CPC H04B 7/185; H01Q 3/2611; H04W 72/0446; H04W 72/0453

(57) ABSTRACT

Provided is a system capable of reducing a residual interference when forming a null of a directional beam from an upper-airspace relay communication station that forms a wide-area cell, toward an antenna of a terrestrial-cell base station. The wide-area cell base station and the terrestrial-cell base station perform service-link communications in the same frequency band using radio frames that are time-synchronized with each other. The wide-area cell base station determines a null scheduling regarding a null allocation on time axis and frequency axis based on information regarding the terrestrial-cell base station, and transmits information on the null scheduling to the terrestrial-cell base station. Based on the information on the null scheduling received from the wide-area cell base station, the terrestrial-cell base station estimates an interference from the wide-area cell to a terminal apparatus of user located in its own cell, determines a user scheduling regarding an allocation of a terminal apparatus of user on time axis and frequency axis, and performs a communication with the terminal apparatus of user located in its own cell.

### TECHNICAL FIELD

The present invention relates to a technology for suppressing an interference from a relay communication station mounted on a HAPS in an upper airspace, etc. to a terrestrial cell.

### BACKGROUND ART

There is conventionally known a base station (hereinafter referred to as a “wide-area cell base station”) that forms a wide-area cell toward a ground or sea surface from a relay communication station of repeater type or base-station-apparatus type which is mounted on a high-altitude platform station (HAPS) (also referred to as a “high-altitude pseudo satellite”) located in an upper airspace, a low earth orbit (LEO) satellite, a geostationary orbit (GEO) satellite, or the like. In an environment including a mixture of a system (hereinafter referred to as an “upper airspace system”) in which the foregoing wide-area cell base station performs a service-link communication with a UE (terminal) and another system (hereinafter referred to as a “terrestrial system”) in which an existing terrestrial-cell base station performs a service-link communication with a UE (terminal), if the communications are performed simultaneously using the same frequency band, a signal from the relay communication station in the upper airspace system cause an interference to the terrestrial system. When the interference from the upper airspace system occurs, a throughput of the terrestrial system is significantly reduced. Similarly, a signal from the terrestrial system also causes an interference to the upper airspace system. When the interference from the terrestrial system occurs, a throughput of the upper airspace system is reduced.

Patent Literature 1 discloses a technology for eliminating or avoiding an area covered by a terrestrial cell and suppressing (reducing) an interference to a terrestrial system by adjusting an antenna system of an upper-airspace HAP to form a directional beam while directing a null toward a terrestrial-cell base station based on a map indicating an eNB (terrestrial-cell base station).

### CITATION LIST

### Patent Literature

Patent Literature 1: US Patent Application Publication No. 2017/0272131.

### SUMMARY OF INVENTION

### Technical Problem

In the case of forming the directional beam while directing the null from the upper airspace system to the terrestrial-cell base station of the terrestrial system in the environment including the mixture of the upper airspace system and the terrestrial system, there is a problem that, in an areas near a cell edge of the terrestrial cell, a downlink (DL) signal from the terrestrial-cell base station is small and it is desirable to reduce a downlink (DL) residual interference from the upper airspace system.

### Solution to Problem

A system according to an aspect of the present invention is a system comprising a wide-area cell base station that forms a wide-area cell toward a ground or sea surface from a service link antenna of a relay communication station mounted on a flying body or floating body located in an upper airspace, and one or plural terrestrial-cell base stations that form a terrestrial cell from an antenna disposed on land or at sea. The wide-area cell base station and the one or plural terrestrial-cell base stations perform service-link communications in a same frequency band using radio frames that are time-synchronized with each other. The wide-area cell base station obtains information regarding the terrestrial-cell base station located in the wide-area cell, determines a null scheduling regarding a null allocation on time axis and frequency axis based on the information regarding the terrestrial-cell base station, and transmits information on the null scheduling to the terrestrial-cell base station. The terrestrial-cell base station receives the information on the null scheduling from the wide-area cell base station, determines a user scheduling regarding an allocation of a terminal apparatus of a user on time axis and frequency axis based on the information on the null scheduling, and performs a communication with a terminal apparatus of a user located in its own cell, based on information on the user scheduling.

In the foregoing system, the information on the null scheduling may include information on a transmission weight matrix Wr to be applied to an antenna of the wide-area cell base station when forming the null, the terrestrial-cell base station may estimate a propagation path response hg between the antenna of the wide-area cell base station and a terminal apparatus of a user g located in its own cell, and estimate an interference power I(r, g) from the wide-area cell to the terminal apparatus of the user g located in its own cell for radio resource r using following equation (1) based on the transmission weight matrix Wr and an estimation result of the propagation path response hg.

$$\begin{matrix}[ Mathematical 1 ] & \\ I ( r , g ) = {‖ {h}_{g} {W}_{r} ‖}^{2} & ( 1 )\end{matrix}$$

Herein, the information on the transmission weight matrix Wr included in the information on the null scheduling may be information (for example, average value or median value) obtained by statistically processing plural elements of the transmission weight matrices Wr.

In the foregoing system, the information on the null scheduling may include information on a parameter for interference estimation that is determined based on an interference model of modelling a spatial distribution of interference power from the wide-area cell to a terminal apparatus of a user located in the terrestrial cell, using a position corresponding to a null point formed by the wide-area cell base station as an origin, and the terrestrial-cell base station may estimate an interference power I (r, g) from the wide-area cell to a terminal apparatus of a user g located in its own cell for a radio resource r based on the information on the parameter for interference estimation.

Herein, the information on the parameter for interference estimation included in the information on the null scheduling may be information (for example, average value or median value) obtained by statistically processing plural values of the parameters for interference estimation.

In the foregoing system, the interference model may be an interference model in which, in an orthogonal coordinate system (x, y, z) with a position corresponding to the null point as the origin, the interference power is set to the z direction, and a distribution of the interference power at positions on an x-y plane is approximated by an elliptical paraboloid, the information on the parameter for interference estimation may be values of coefficients aᵣ, bᵣ and cᵣ in a following equation (2) defined in the orthogonal coordinate system (x, y, z), and the terrestrial-cell base station may estimate an interference power I_{modelA} (r, g) from the wide-area cell to a terminal apparatus of a user g located at a coordinate position (x_{g}, y_{g}) of its own cell for each radio resource r based on the following equation (2) and the values of the coefficients aᵣ, bᵣ and cᵣ.

$$\begin{matrix}[ Mathematical 2 ] & \\ {I}_{model A} ( r , g ) = {a}_{r} {x}_{g}^{2} + {b}_{r} {x}_{g} {y}_{g} + {c}_{r} {y}_{g}^{2} & ( 2 )\end{matrix}$$

Herein, the information on the parameter for interference estimation may be a value obtained by normalizing two coefficients by another coefficient among the coefficients aᵣ, bᵣ and cᵣ, and the terrestrial-cell base station may estimate an interference power from the wide-area cell to a terminal apparatus of a user g located at a coordinate position (x_{g}, y_{g}) of the its own cell for each radio resource r, based on the value of the coefficient.

For example, the information on the parameter for interference estimation may be values of coefficients bᵣ/aᵣ and cᵣ/aᵣ, and the terrestrial-cell base station may calculate a normalized value of the interference power I_{modelA} (r, g) as an estimated value of interference power from the wide-area cell to a terminal apparatus of a user g located at a coordinate position (x_{g}, y_{g}) of the cell for each radio resource r, based on a following equation (3) and the values of the coefficients bᵣ/aᵣ and cᵣ/aᵣ.

$$\begin{matrix}[ Mathematical 3 ] & \\ {\hat{I}}_{model A} ( r , g ) = {x}_{g}^{2} + \frac{{b}_{r}}{{a}_{r}} {x}_{g} {y}_{g} + \frac{{c}_{r}}{{a}_{r}} {y}_{g}^{2} & ( 3 )\end{matrix}$$

In the foregoing system, the interference model may be an interference model in which, in the orthogonal coordinate system (x, y, z) with a position corresponding to the null point as the origin, the interference power is set to the z direction, a distribution of the interference power at positions on the x-y plane is approximated by an elliptical paraboloid, and the orthogonal coordinates are rotated by a rotation angle or so that the x-axis coincides with the minor axis of an ellipse having equal power when the elliptical paraboloid is projected onto the x-y plane, the information on the parameter for interference estimation may be a value of a coefficient aᵣ′ in a following equation (4) defined in the rotated orthogonal coordinate system (x′, y′, z), and the terrestrial-cell base station may estimate an interference power I_{modelB} (r, g) from the wide-area cell to the terminal apparatus of the user g located at a coordinate position (x_{g}′, y_{g}′) of its own cell for each radio resource r based on the following equation (4) and the value of the coefficient aᵣ′.

$$\begin{matrix}[ Mathematical 4 ] & \\ {I}_{model B} ( r , g ) = {a}_{r}^{′} {x}_{g}^{′2} = {{a}_{r}^{′} ( cos ( {ϕ}_{r} ) {x}_{g} - sin ( {ϕ}_{r} ) {y}_{g} )}^{2} & ( 4 )\end{matrix}$$

Herein, the terrestrial-cell base station may calculate a normalized value of the interference power I_{modelB} (r, g) as an estimated value of interference power from the wide-area cell to a terminal apparatus of a user g located at a coordinate position (x_{g}′, y_{g}′) of its own cell for each radio resource r, based on a following equation (5) obtained by dividing the foregoing equation (4) by the coefficient aᵣ′.

$$\begin{matrix}[ Mathematical 5 ] & \\ {\hat{I}}_{model B} ( r , g ) = {x}_{g}^{′2} = {( cos ( {ϕ}_{r} ) {x}_{g} - sin ( {ϕ}_{r} ) {y}_{g} )}^{2} & ( 5 )\end{matrix}$$

In the foregoing system, the interference model may be an interference model in which, in the orthogonal coordinate system (x, y, z) with a position corresponding to the null point as the origin, the interference power is set to the z direction, and a distribution of the interference power at positions on an x-y plane is approximated by a paraboloid of revolution, the information on the parameter for interference estimation may be a value of a coefficient aᵣ″ in following equation (6) defined in the orthogonal coordinate system (x, y, z), and the terrestrial-cell base station may estimate an interference power I_{modelC} (r, g) from the wide-area cell to the terminal apparatus of the user g located at a coordinate position (x_{g}, y_{g}) of its own cell for each radio resource r based on the following equation (6) and the value of the coefficient aᵣ″.

$$\begin{matrix}[ Mathematical 6 ] & \\ {I}_{model C} ( r , g ) = {a}_{r}^{″} ( {x}_{g}^{2} + {y}_{g}^{2} ) & ( 6 )\end{matrix}$$

Herein, a normalized value of the interference power I_{modelB} (r, g) may be calculated as an estimated value of interference power from the wide-area cell to a terminal apparatus of a user g located in its own cell, for a radio resource r at a coordinate position (x_{g}′, y_{g}′), using a following equation (7) obtained by dividing the foregoing equation (6) by the coefficient aᵣ″.

$$\begin{matrix}[ Mathematical 7 ] & \\ {\hat{I}}_{model C} ( r , g ) = {x}_{g}^{2} + {y}_{g}^{2} & ( 7 )\end{matrix}$$

In the foregoing system, each of the plural terrestrial-cell base stations may perform a service link communication using a Time Division Duplex (TDD) system and transmit switching information on uplink (UL) and downlink (DL) of its own cell, to the wide-area cell base station, the wide-area cell base station may receive the switching information on uplink (UL) and downlink (DL) from each of the plural terrestrial-cell base stations, obtain information on terrestrial-cell base stations located in the wide-area cell from a terrestrial-cell base station database, determine a null scheduling regarding an allocation of a null on time axis and frequency axis for each of the terrestrial-cell base stations, based on the switching information on uplink (UL) and downlink (DL) received from each of the plural terrestrial-cell base stations and the information on the terrestrial-cell base station obtained from the terrestrial-cell base station database, and transmit information on the null scheduling to each of the plural terrestrial-cell base stations, and each of the plural terrestrial-cell base stations may receive the information on the null scheduling regarding the terrestrial-cell base station itself from the wide-area cell base station, estimate an interference from the wide-area cell to a terminal apparatus of a user located in its own cell, based on the information on the null scheduling, determine a user scheduling regarding an allocation of a terminal apparatus of a user on time axis and frequency axis, and performs a communication with a terminal apparatus of a user located in its own cell, based on information on the user scheduling.

Herein, in the user scheduling, the terrestrial-cell base station may perform an initialization process including setting a first set of user numbers g of terminal apparatuses of plural (Nu) unallocated users and setting a second set of plural (Nr=rₘₐₓ) radio resources to be processed by a greedy method in order of resource number r, and a process of setting the r-th resource number r of the second set as a resource number r to be allocated, in order from a first (r=1) to an Nr-th (r=rₘₐₓ) resource number r of the second set, calculating an interference power when the radio resource of resource number r is allocated, allocating a user number g of a terminal apparatus of a user for which the calculated value of the interference power or a metric value for determination corresponding to the calculated value of the interference power is smallest, as a user number gr to be allocated to the resource number r, and removing the user number gr for which the allocation is confirmed, from the first set.

In the foregoing system, each of the plural terrestrial-cell base stations may perform a service link communication using a Frequency Division Duplex (FDD) method, the wide-area cell base station may obtain information regarding the plural terrestrial-cell base stations located in the wide-area cell from a terrestrial-cell base station database, determine a null scheduling regarding an allocation of a null on time axis and frequency axis for each of the terrestrial-cell base stations, based on the information regarding the terrestrial-cell base stations obtained from the terrestrial-cell base station database, and transmit information on the null scheduling to each of the plural terrestrial-cell base stations, and each of the plural terrestrial-cell base stations may receive the information on the null scheduling regarding the station itself from the wide-area cell base station, estimate an interference from the wide-area cell to a terminal apparatus of a user located in its own cell, based on the information on the null scheduling, determine a user scheduling regarding an allocation of a terminal apparatus of a user on time axis and frequency axis, and perform a communication with the a terminal apparatus of a user located in its own cell, based on the information on the user scheduling.

Herein, in the user scheduling, the terrestrial-cell base station may perform an initialization process including setting a first set of user numbers g of terminal apparatuses of plural (Nu) unallocated users and setting a second set of plural (Nr=rₘₐₓ) radio resources to be processed allocated by a greedy method in order of resource numbers r, and a process of setting the r-th resource number r of the second set as a resource number r to be allocated, in order from a first (r=1) to an Nr-th (r=rₘₐₓ) resource number r of the second set, calculating an interference power when the radio resource of resource number r is allocated, allocating a user number g of a terminal apparatus of a user for which the calculated value of the interference power or a metric value for determination corresponding to the calculated value of the interference power is smallest, as a user number gr to be allocated to the resource number r, and removing the user number g, for which the allocation is confirmed, from the first set.

### Advantageous Effects of Invention

According to the present invention, it is possible to reduce a residual interference when forming a null of a directional beam from an upper-airspace relay communication station that forms a wide-area cell, toward an antenna of the terrestrial-cell base station.

### BRIEF DESCRIPTION OF DRAWINGS

FIG. 1 is a schematic configuration diagram showing an example of an overall configuration of a communication system including a HAPS according to an embodiment.

FIG. 2 is a perspective view showing an example of the HAPS according to the embodiment.

FIG. 3 is a side view showing another example of the HAPS according to the embodiment.

FIG. 4 is a perspective view showing an example of an array antenna for service link of the HAPS according to the embodiment.

FIG. 5 is a perspective view showing another example of an array antenna for service link of the HAPS according to the embodiment.

FIG. 6 is an illustration showing a problem in the case of performing a beamforming in MU-MIMO using the array antenna of the HAPS.

FIG. 7 is an illustration showing a problem when forming a null of beamforming from the HAPS toward a terrestrial base station (antenna).

FIG. 8 is an illustration showing an example of null sweeping that changes the position of the null of beamforming formed from the HAPS toward the terrestrial cell, according to the embodiment.

FIG. 9A is an illustration showing an example of null sweeping in the case of forming two nulls by switching between them for each radio resource from the HAPS toward the terrestrial cell, according to the embodiment.

FIG. 9B is an illustration showing an example of a relationship between radio resources of user scheduling, nulls, and terminal apparatuses of terrestrial cell users in the null sweeping.

FIG. 10 is an illustration showing an example of a user schedule algorithm in the case of an exact method for estimating an interference power of a terrestrial cell user (terminal apparatus) using a transmission weight matrix applied to an array antenna for service link of the HAPS, according to the embodiment.

FIG. 11A is an illustration showing an example of a model of interference power distribution obtained by modeling a spatial distribution of interference power from the HAPS centered on a null point of the terrestrial cell, according to the embodiment.

FIG. 11B is an illustration showing an example of a model of interference power distribution obtained by modeling a spatial distribution of interference power from the HAPS centered on a null point of the terrestrial cell, according to the embodiment.

FIG. 11C is an illustration showing an example of a model of interference power distribution obtained by modeling a spatial distribution of interference power from the HAPS centered on a null point of the terrestrial cell, according to the embodiment.

FIG. 12A is an illustration showing a two-dimensional representation of a relationship between the contour lines of the interference power and the coordinates in an interference estimation method A using the interference model in FIG. 11A.

FIG. 12B is an illustration showing a two-dimensional representation of a relationship between the contour lines of the interference power and the coordinates in an interference estimation method B using the interference model in FIG. 11B.

FIG. 12C is an illustration showing a two-dimensional representation of a relationship between the contour lines of the interference power and the coordinates in an interference estimation method C using the interference model in FIG. 11C.

FIG. 13 is an illustration showing an example of a coefficient determination method for determining coefficients of a calculation formula for interference power in the interference estimation method A applicable to null sweeping, according to the embodiment.

FIG. 14 is an illustration showing an example of a propagation path vector between each element of the array antenna for service link of the HAPS and a target point of the terrestrial cell.

FIG. 15 is an illustration showing an example of a coefficient determination method for determining coefficients of a calculation formula for interference power in the interference estimation method B applicable to null sweeping, according to the embodiment.

FIG. 16A is an illustration showing an example of rotation of coordinate axes in the coefficient determination method of the interference estimation method B.

FIG. 16B is an illustration showing an example of rotation of coordinate axes in the coefficient determination method of the interference estimation method B.

FIG. 17 is an illustration showing an example of a coefficient determination method for determining coefficients of a calculation formula for interference power in the interference estimation method C applicable to null sweeping, according to the embodiment.

FIG. 18 is an illustration showing an example of a flow of control information in the entire system in the case that a user scheduling method using interference power estimated by an exact method using a transmission weight matrix is applied, according to the embodiment.

FIG. 19 is an illustration showing an example of a flow of control information in the entire system in the case that a user scheduling method using interference power estimated by the interference estimation method A is applied, according to the embodiment.

FIG. 20 is an illustration showing an example of a flow of control information in the entire system in the case that a user scheduling method using interference power estimated by the interference estimation method B is applied, according to the embodiment.

FIG. 21 is an illustration showing an example of a flow of control information in the entire system in the case that a user scheduling method using interference power estimated by the interference estimation method C is applied, according to the embodiment.

FIG. 22A is an illustration showing setting conditions in an example of a computer simulation of interference power estimation using each of the exact method, interference estimation method A, interference estimation method B and interference estimation method C, according to the embodiment.

FIG. 22B is an illustration showing setting conditions in an example of a computer simulation of interference power estimation using each of the exact method, the interference estimation method A, the interference estimation method B and the interference estimation method C, according to the embodiment.

FIG. 23A is an illustration showing an example of a result of the computer simulation in which an interference power is estimated using the exact method according to the embodiment under the setting conditions of FIGS. 22A and 22B.

FIG. 23B is an illustration showing an example of a result of the computer simulation in which an interference power is estimated using the interference estimation method A according to the embodiment under the setting conditions of FIGS. 22A and 22B.

FIG. 23C is an illustration showing an example of a result of the computer simulation in which an interference power is estimated using the interference estimation method B according to the embodiment under the setting conditions of FIGS. 22A and 22B.

FIG. 23D is an illustration showing an example of a result of the computer simulation in which an interference power is estimated using each of the interference estimation methods C according to the embodiment under the setting conditions of FIGS. 22A and 22B.

FIG. 24A is an illustration showing setting conditions in another example of a computer simulation of interference power estimation using each of the exact method, the interference estimation method A, the interference estimation method B and the interference estimation method C, according to the embodiment.

FIG. 24B is an illustration showing setting conditions in another example of a computer simulation of interference power estimation using each of the exact method, the interference estimation method A, the interference estimation method B and the interference estimation method C, according to the embodiment.

FIG. 25A is an illustration showing an example of a result of a computer simulation in which an interference power is estimated using the exact method according to the embodiment under the setting conditions of FIGS. 24A and 24B.

FIG. 25B is an illustration showing an example of a result of the computer simulation in which an interference power is estimated using the interference estimation method A according to the embodiment under the setting conditions of FIGS. 24A and 24B.

FIG. 25C is an illustration showing an example of a result of the computer simulation in which an interference power is estimated using the interference estimation method B according to the embodiment under the setting conditions of FIGS. 24A and 24B.

FIG. 25D is an illustration showing an example of a result of the computer simulation in which an interference power is estimated using each of the interference estimation methods C according to the embodiment under the setting conditions of FIGS. 24A and 24B.

FIG. 26 is an illustration showing an example of a common algorithm for a user scheduling method, to which the interference estimation method A, the interference estimation method B and the interference estimation method C based on the interference model are applied, according to the embodiment.

FIG. 27A is an illustration showing an example of the relationship between the contour lines of interference power and coordinates in the interference estimation method A to be combined with a reduction in the number of parameters.

FIG. 27B is an illustration showing an example of an algorithm of a user scheduling method A-2 in which the interference estimation method A is combined with the reduction in the number of parameters.

FIG. 28A is an illustration showing an example of the relationship between the contour lines of interference power and coordinates in the interference estimation method B to be combined with a reduction in the number of parameters.

FIG. 28B is an illustration showing an example of an algorithm of a user scheduling method B-2 in which the interference estimation method B is combined with the reduction in the number of parameters.

FIG. 29A is an illustration showing an example of the relationship between the contour lines of interference power and coordinates in the interference estimation method C to be combined with a reduction in the number of parameters.

FIG. 29B is an illustration showing an example of an algorithm of a user scheduling method C-2 in which the interference estimation method C is combined with the reduction in the number of parameters.

FIG. 30 is an illustration showing an example of a flow of control parameter information in the entire system in the case that the user scheduling method A-2 is applied, according to the embodiment.

FIG. 31 is an illustration showing an example of a flow of control parameter information in the entire system in the case that the user scheduling method B-2 is applied, according to the embodiment.

FIG. 32 is an illustration showing an example of a flow of control parameter information in the entire system in the case that the user scheduling method C-2 is applied, according to the embodiment.

FIG. 33 is an illustration showing an example of a result of computer simulation in which the improvement effect of SINR in the terrestrial cell is calculated in the cases that the user scheduling is performed by estimating the interference power by the exact method and the interference estimation methods A-2, B-2C-2 using the model, according to the embodiment.

FIG. 34 is an illustration showing another example of a result of computer simulation in which the improvement effect of SINR in the terrestrial cell is calculated in the cases that the user scheduling is performed by estimating the interference power by the exact method and the interference estimation methods A-2, B-2C-2 using the model, according to the embodiment.

FIG. 35 is an illustration showing an example of the overall configuration of a communication system having a terrestrial-base station database, according to the embodiment.

FIG. 36 is a block diagram showing an example of a main configuration of a relay communication station mounted on the HAPS in the communication system of FIG. 35.

FIG. 37 is a block diagram showing another example of a main configuration of the relay communication station mounted on the HAPS in the communication system of FIG. 35.

FIG. 38 is a block diagram showing an example of a main configuration of a terrestrial-cell base station in the communication system of FIG. 35.

FIG. 39 is a flowchart showing an example of a processing flow in the HAPS base station and the terrestrial-cell base station when performing a beamforming control and a service link communication involving a null formation in the communication system according to the embodiment.

### DESCRIPTION OF EMBODIMENTS

Hereinafter, embodiments of the present invention are described with reference to the drawings.

The system according to the embodiment described in the present specification is a communication system (HAPS system) provided with an upper airspace staying-type communication relay apparatus (HAPS), which is a flying body or a floating body mounted on a relay communication station of a wide-area cell base station (HAPS base station) that forms a cell toward a ground or sea surface and can perform a MU-MIMO communication using a multi-element array antenna between the station itself and plural terminal apparatuses (UE) located in the cell. In the case that a terrestrial cell (second cell) formed by an existing terrestrial base station using the same frequency band is located in a HAPS cell (first cell) that is a wide-area cell, the present communication system (HAPS system) can reduce a residual interference when suppressing an interference by forming a null of a directional beam from the relay communication station of the HAPS toward the antenna of the terrestrial-cell base station. The communication system according to the present embodiment is suitable for realizing a three-dimensional network for the next-generation mobile communications such as the fifth generation, etc., which supports simultaneous connection to a large number of terminal apparatuses, low latency, and the like.

In particular, in the system of the present embodiment, a null sweeping is performed to change the position of the null of the directional beam formed from the relay communication station of the HAPS toward the terrestrial cell for each radio resource, thereby suppressing (reducing) an interference with downlink communication of each terminal apparatus at each of the center part and the cell edge part of the terrestrial cell, and improving the SINR (Signal to Interference and Noise Power Ratio) over the entire terrestrial cell.

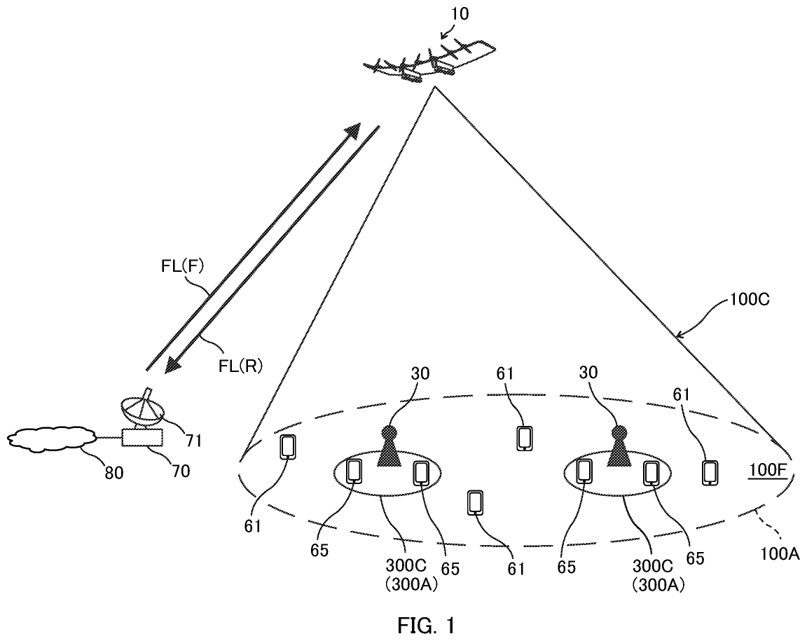

FIG. 1 is a schematic configuration diagram showing an example of an overall configuration of a communication system including a HAPS (upper airspace staying-type communication relay apparatus) according to an embodiment. In FIG. 1, the HAPS system configuring the communication system in the present embodiment is provided with a high-altitude platform station (hereinafter, also called a “HAPS” or “upper airspace PF (platform)”), (also called a “high-altitude pseudo satellite” or “stratospheric platform”) 10 as an upper airspace staying-type communication relay apparatus (radio relay apparatus) that is a flying body or floating body mounted on a relay communication station. The HAPS 10 is located in an airspace at a predetermined altitude and forms a three-dimensional cell (hereinafter also referred to as a “HAPS cell”) 100C as a wide-area cell (first cell). The HAPS (upper airspace PF) 10 is a flying body or floating body (for example, a solar plane, airship, drone, balloon), which is controlled to float or fly and stary in an airspace (floating airspace) at a predetermined altitude above a ground or sea level by an autonomous control or external control, and which is equipped with a relay communication station. It is noted that the HAPS (upper airspace PF) 10, which can function as a communication relay apparatus of upper airspace staying-type, may be a configuration having a relay communication apparatus installed in an artificial satellite such as a low earth orbit (LEO) satellite or a geostationary orbit (GEO) satellite, etc. Furthermore, the communication system of the present embodiment may include one or plural terminal apparatuses with which the HAPS 10 communicates, and may also include a gateway station (feeder station) described later.

The airspace in which the HAPS 10 is located is, for example, a stratospheric airspace with an altitude of 11 [km] or more and 50 [km] or less on land (or on water such as at sea or on lake). This airspace may be an airspace with an altitude of 15 [km] or more and 25 [km] or less where weather conditions are relatively stable, and may specifically be an airspace with an altitude of about 20 [km].

Since the HAPS flies in an airspace location that is lower than the flight altitude of general artificial satellites and higher than base stations on land or at sea, it can ensure high visibility while experiencing smaller propagation loss than satellite communications. This feature makes it possible to provide a communication service from the HAPS to a terminal apparatus (mobile station) 61 that is user apparatus such as a cellular mobile terminal, etc. on land or at sea. By providing the communication service from the HAPS, since a small number of HAPSs is capable of covering a wide area that is conventionally covered by a large number of base stations on land or at sea, there is an advantage of providing a stable communication service at low cost.

The relay communication station of the HAPS 10 forms a beam for radio communication with a user's terminal apparatus (hereinafter referred to as “UE” (user equipment)) toward a ground surface (or sea surface), thereby forming a HAPS cell 100C capable of performing a radio communication with the UE 61. The radius of a service area (also called a “HAPS service area”) 100A configured with a footprint 100F on land (or at sea) of the HAPS cell 100C is, for example, several tens of kilometers to 100 kilometers.

It is noted that, in the present embodiment, the relay communication station of the HAPS 10 may form a plurality of three-dimensional cells (for example, three cells or seven cells) and form the service area 100A configured with plural footprints on land (or the sea) of the plurality of the three-dimensional cells.

The communication system of the present embodiment is an environment including a mixture of the HAPS 10 that is equipped with an upper-airspace relay communication station configuring a wide-area cell base station (hereinafter also referred to as a “HAPS base station”), and a low-positioned base station (hereinafter referred to as a “terrestrial-cell base station” or “terrestrial base station”) 30 that forms a cell to be an interference suppression target located on land or at sea. In the example of FIG. 1, plural antennas of the low-positioned terrestrial base stations 30 (hereinafter also referred to as “base station antennas”) are located inside the HAPS cell 100C, and a cell (hereinafter referred to as “terrestrial cell”) 300C of the terrestrial base station 30 smaller than the footprint 100F of cell 100C is formed inside the service area 100A consisting of the footprint 100F of the three-dimensional cell 100C.

The wide-area cell base station including the relay communication station mounted on the HAPS 10 and the terrestrial base station (for example, eNodeB, gNodeB) 30 respectively uses radio frames time-synchronized with each other and the same frequency band for radio communications of service links between the UEs 61 and 65 respectively located in their own cells 100C and 300C. The terrestrial base station 30 may be configured such that the RRH (Remote Radio Head) having the base station antenna and the BBU (Base Band Unit) are connected via the optical line. In this case, the RRH having the base station antenna is located at the location of the base station 30 in FIG. 1.

The relay communication station mounted on the HAPS 10 is, for example, a base station (for example, eNodeB, gNodeB) for performing a radio communication with a gateway station (also called a “feeder station”) 70 that serves as a relay station connected to a core network of a mobile communication network 80 on land (or at sea) side and has an antenna 71 facing toward the upper airspace. The relay communication station of the HAPS 10 is connected to the core network of the mobile communication network 80 via the feeder station 70 disposed on land or at sea. The communication between the HAPS 10 and the feeder station 70 may be performed by a radio communication using radio waves such as microwaves, or by an optical communication using laser light or the like.

The relay communication station (also called “radio relay station”) mounted on the HAPS 10 may be a relay communication station of repeater-type, or may be a relay communication station of base-station-apparatus type. The relay communication station of repeater type configures the wide-area cell base station in combination with a base station apparatus mounted on the feeder station 70. The relay communication station of base-station-apparatus type functions as the wide-area cell base station.

The relay communication station of repeater type has, for example, a repeater and a frequency conversion apparatus. The repeater has a low noise amplifier that amplifies a reception signal of service link received via a service link antenna, a power amplifier that amplifies a transmission signal to be transmitted via the service link antenna, and so on. The frequency conversion apparatus performs a conversion between the service link frequency and the feeder link frequency. The feeder station 70 has, for example, a base station apparatus and a frequency conversion apparatus. The base station apparatus has a baseband processing apparatus for processing a baseband signal of service link, a communication interface section for communicating with the core network via a backhaul line, and so on. The frequency conversion apparatus performs a conversion between the frequency of the service link signal input/output to/from the base station apparatus and the frequency of the feeder link signal.

The relay communication station of base-station-apparatus type has, for example, the base station apparatus and a feeder link transceiver. The base station apparatus has a low noise amplifier that amplifies a reception signal of the service link, a power amplifier that amplifies a transmission signal to be transmitted via the service link antenna, a baseband processing apparatus for processing a baseband signal of the service link, and so on. The feeder link transceiver transmits and receives signals of the backhaul line, which are transmitted and received between the transceiver and the feeder station 70. The feeder station 70 transmits and receives signals of the backhaul line, which are transmitted and received between the feeder station and the relay communication station in the upper airspace.

The HAPS 10 may autonomously control a floating movement (flight) of the HAPS itself and a process in the relay communication station by executing a control program by a control section that is configured with a computer, etc. built in the inside. For example, each of the HAPSs 10 may acquire current position information (for example, GPS position information) of the HAPS itself, position control information (for example, flight schedule information) stored in advance, position information of another HAPS located in a peripheral space, and so on, and may autonomously control the floating movement (flight) and the process in the relay communication station based on these kinds of information.

The floating movement (flight) of the HAPS 10 and the process in the relay communication station may be controllable by a management apparatus (also referred to as a “remote control apparatus”) as a management apparatus that is provided in a communication center or the like of the mobile communication network 80. The management apparatus can be configured with, for example, a computer apparatus such as a PC, a server, or the like. In this case, the HAPS 10 may incorporate a communication terminal apparatus for control (for example, mobile communication module) so that it can receive control information from the management apparatus and transmit various kinds of information such as monitoring information to the management apparatus, and may be assigned terminal identification information (for example, IP address, phone number, etc.) so that it can be identified from the management apparatus. The MAC address of the communication interface may be used to identify the communication terminal apparatus for control. The HAPS 10 may transmit information regarding the floating movement (flight) of the HAPS itself or a surrounding HAPS and the process at the relay communication station, and monitoring information such as information regarding the status of HAPS 10 and observation data acquired by various kinds of sensors, to a predetermined destination such as the management apparatus, etc. The control information may include information on the target flight route of HAPS. The monitoring information may include at least one of information on current position, flight-route history information, velocity relative to the air, velocity relative to the ground and propulsion direction of the HAPS 10, wind velocity and wind direction of airflow around the HAPS 10, and atmospheric pressure and temperature around the HAPS 10.

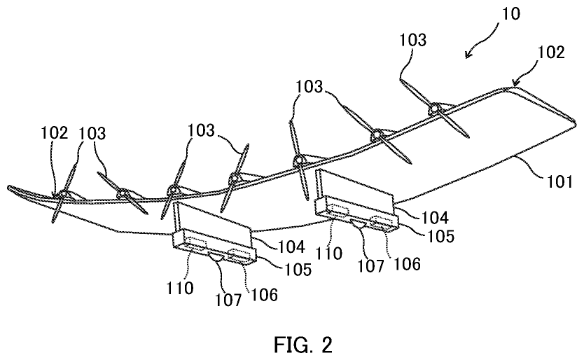

FIG. 2 is a perspective view showing an example of the HAPS 10 used in the communication system of the embodiment.

The HAPS 10 in FIG. 2 is a solar plane-type HAPS, and is provided with a main wing section 101 with both end edge sections curved upwards in the longitudinal direction, and plural motor-driven propellers 103 as propulsion apparatuses for a bus power system at one end edge section in the short side direction of the main wing section 101. A solar-power generation panel (hereinafter referred to as “solar panel”) 102 as a solar-power generation section having a solar-power generation function is provided on the upper surface of the main wing section 101. Pods 105 as plural equipment accommodating sections for accommodating mission equipment are connected to two locations in the longitudinal direction of the lower surface of the main wing section 101 via plate-shaped connecting sections 104. Inside each pod 105, a relay communication station 110 as a mission equipment and a battery 106 are housed. A wheel 107 used for takeoff and landing is provided on the lower surface side of each pod 105. The electric power generated by the solar panel 102 is stored in the battery 106, and the motors of propellers 103 are rotationally driven and the radio relay process by the relay communication station 110 is executed, by the electric power supplied from the battery 106.

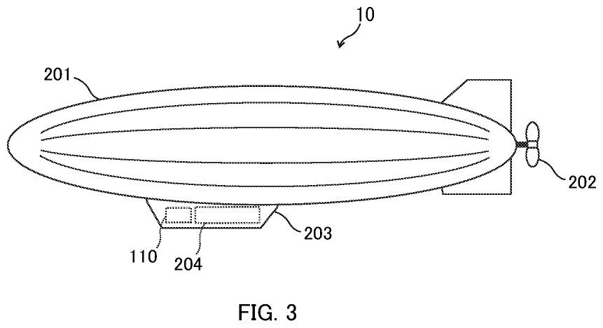

FIG. 3 is a side view showing another example of the HAPS 10 used in the communication system of the embodiment. The HAPS 10 in FIG. 3 is an unmanned airship-type HAPS and can be equipped with a large capacity battery because of its large payload. The HAPS 10 is provided with an airship main body 201 filled with a gas such as helium gas, etc. for floating by buoyancy, a motor-driven propeller 202 as a propulsion apparatus for a bus power system, and an equipment accommodating section 203 for accommodating mission equipment. Inside the equipment accommodating section 203, the relay communication station 110 and a battery 204 are housed. The motor of the propeller 202 is rotationally driven and the radio relay process by the relay communication station 110 is executed, by the electric power supplied from the battery 204. It is noted that a solar panel having a solar-power generation function may be provided on the upper surface of the airship main body 201, and the electric power generated by the solar panel may be stored in the battery 204.

It is noted that, in the following embodiments, although the upper airspace staying-type communication relay apparatus for wirelessly communicating with the UE 61 is illustrated and described with respect to either the solar plane-type HAPS 10 or the unmanned airship-type HAPS 20 in FIG. 2, the upper airspace staying-type communication relay apparatus may also be the unmanned airship-type HAPS 10 in FIG. 3. Moreover, the following embodiments can be similarly applied to other upper airspace staying-type communication relay apparatuses other than the HAPS 10.

Links FL(F) and FL(R) between the HAPS 10 and the gateway station (hereinafter abbreviated as “GW station”) 70 serving as a feeder station are called “feeder links”, and a link between the HAPS 10 and the UE 61 is called a “service link”. In particular, the section between the HAPS 10 and the GW station 70 is called the “radio section of feeder link”. In addition, the downlink of communication from the GW station 70 to the UE 61 via the HAPS 10 is also called the “forward link” FL(F), and the uplink of communication from the UE 61 to the GW station 70 via the HAPS 10 is also called the “reverse link” FL(R).

In the communication system of the present embodiment, the duplexing method for the uplink and downlink of the radio communication between the terrestrial base station 30 and the UE 65 is not limited to a specific method, and may be, for example, a Time Division Duplex (TDD) method or a Frequency Division Duplex (FDD) method. In addition, the access method for radio communication between the terrestrial base station 30 and the UE 65 is not limited to a specific method, and may be, for example, an FDMA (Frequency Division Multiple Access) method, a TDMA (Time Division Multiple Access) method, a CDMA (Code Division Multiple Access) method, or an OFDMA (Orthogonal Frequency Division Multiple Access) method.

Similarly, the duplexing method of the uplink and downlink of the radio communication with the UE 61 via the relay communication station 110 is not limited to a specific method, and may be, for example, the Time Division Duplexing (TDD) method or the Frequency Division Duplexing (FDD) method. Further, the access method for radio communication with the UE 61 via the relay communication station 110 is not limited to a specific method, and may be, for example, the FDMA method, the TDMA method, the CDMA method, or the OFDMA method.

The radio communication of the service link in the present embodiment uses a massive MIMO (Multiple-Input Multiple-Output) transmission method that has functions such as diversity coding, transmission beamforming, and Spatial Division Multiplexing (SDM), etc., and performs a multi-layer transmission using an array antenna having a large number of antenna elements. In particular, in the present embodiment, in the downlink communication from the relay communication station of the HAPS 10 to plural UEs 61 in the cell, an MU-MIMO (Multi-User MIMO) technology is used, which transmits signals to plural different UEs 61 at the same time and with the same frequency. By performing MU-MIMO transmission using an array antenna having a large number of antenna elements, it is capable of performing a communication by directing an appropriate beam to each UE 61 according to the communication environment of each UE 61, thereby improving the communication quality of the entire cell. Furthermore, since it is capable of communicating with plural UEs 61 using the same radio resources (time and frequency resources), the system capacity can be expanded.

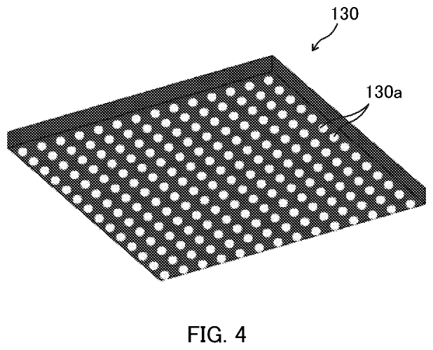

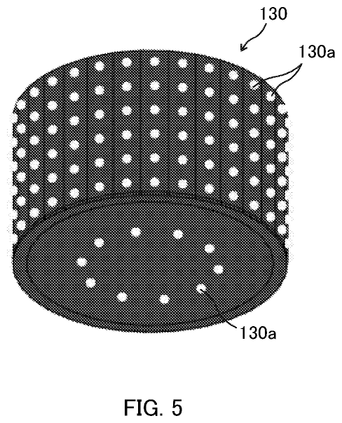

Each of FIGS. 4 and 5 is a perspective view showing an example of an array antenna 130 configured with multi-element that can be used in the MU-MIMO transmission method in the HAPS 10 of the present embodiment.

The array antenna 130 in FIG. 4 is a planar-type array antenna having a flat board-formed antenna base, in which a large number of antenna elements 130a such as patch antennas are disposed two-dimensionally in axial directions perpendicular to each other along the planar antenna surface of the antenna base.

The array antenna 130 in FIG. 5 is a cylinder-type array antenna having a cylindrical or columnar antenna base, in which a large number of antenna elements 130a such as patch antennas are disposed along each of the axial and circumferential directions of the circumferential side surface serving as a first antenna surface of the antenna base. In the array antenna 130 of FIG. 5, as shown in the figure, plural antenna elements 130a such as patch antennas may be disposed in a circular shape along the bottom surface serving as the second antenna surface. Furthermore, the antenna base in FIG. 5 may be an antenna base having a polygonal tube shape or a polygonal circular-column shape.

It is noted that the shape of the array antenna 130 and the number, type and placement of the antenna elements are not limited to those exemplified in FIGS. 4 and 5.

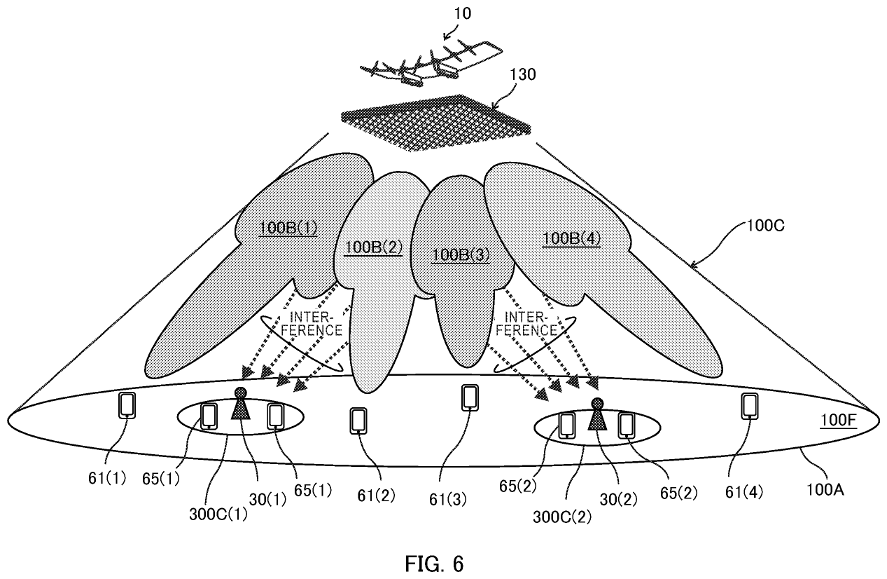

FIG. 6 is an illustration showing a problem when performing a beamforming in the MU-MIMO transmission method using the array antenna 130 of the HAPS 10. In the service link SL between the array antenna 130 of the HAPS 10 and the service area 100A (footprint 100F of cell 100C) in FIG. 6, by performing a beamforming that directs appropriate high-gain beams 100B(1) to 100B(4) to the UEs 61(1) to 61(4) individually in accordance with the communication environment of each UE 61, compensates for long-distance propagation loss and communicates, using the MU-MIMO transmission method, it is capable of improving a communication quality. In particular, in the case of using the MU-MIMO transmission method in which the same radio resource (for example, the same time/frequency resource block (RB)) is used to communicate with plural UEs 61 in the service link SL, the system capacity can be improved.

However, in the environment where the HAPS 10 and the terrestrial base stations 30(1) and 30(2) coexist as shown in FIG. 6, when the HAPS 10 and the terrestrial base stations 30(1) and 30(2) use the same frequency band to simultaneously communicate with UEs 61 and 65 located in each cell, the downlink radio transmission signal transmitted from the HAPS 10 may cause an interference for a service link communication (hereinafter also referred to as “terrestrial system communication”) between the HAPS and each of the terrestrial base stations 30(1) and 30(2) and UEs 65(1) and 65(2) located in the terrestrial cells 300C(1) and 300C(2). When this interference from the HAPS 10 occurs, the throughput of communication between the terrestrial base stations 30(1) and 30(2) and the UE 65 drops significantly.

In the present embodiment, in the HAPS 10, based on the location information on the base station antenna of the terrestrial base station, a beamforming control of the HAPS cell is performed so that a null of a beam pattern (profile of the spatial distribution of the beam) is directed toward the terrestrial base station (antenna) located in the HAPS cell. This suppresses an interference in the communications of the terrestrial system, which is caused by the HAPS 10 in, without causing a significant decrease in a communication quality when transmitting a desired signal by multiple beams to each of the plural UEs 61 located in the HAPS cell.

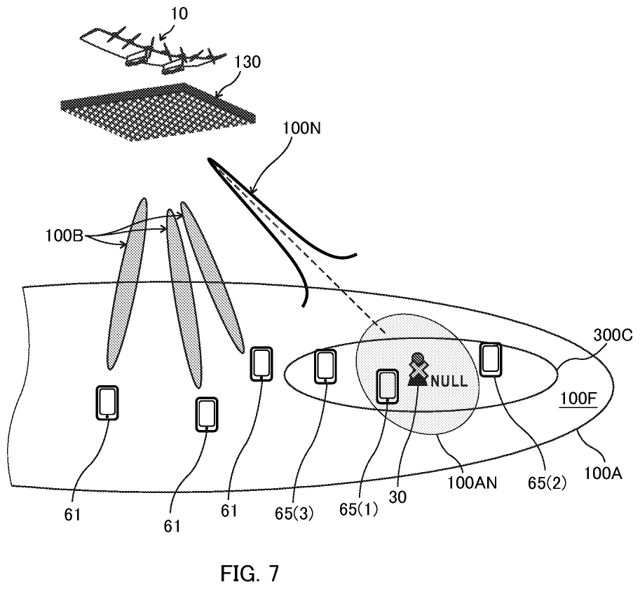

FIG. 7 is an illustration showing a problem when forming a null of beamforming from the HAPS toward the terrestrial base station (antenna). As shown in FIG. 7, when a null 100N of a beam pattern is formed from the array antenna 130 of HAPS 10 to the terrestrial base station (antenna) 30 located in the HAPS service area 100A, the UE 65(1) at the center of the cell, in which the terrestrial base station 30 of the terrestrial cell 300C is located, receives a strong signal from the terrestrial base station 30 and receives little interference from the array antenna 130 of the HAPS 10 in the upper airspace. However, in the UEs 65(2) and 65(3) located near the cell edges of the terrestrial cell 300C, since the signals received from the terrestrial base station 30 are weak and the interference received from the array antenna 130 of the HAPS 10 in the upper airspace is large, the overall communication quality (for example, SINR) of the terrestrial cell 300C is poor.

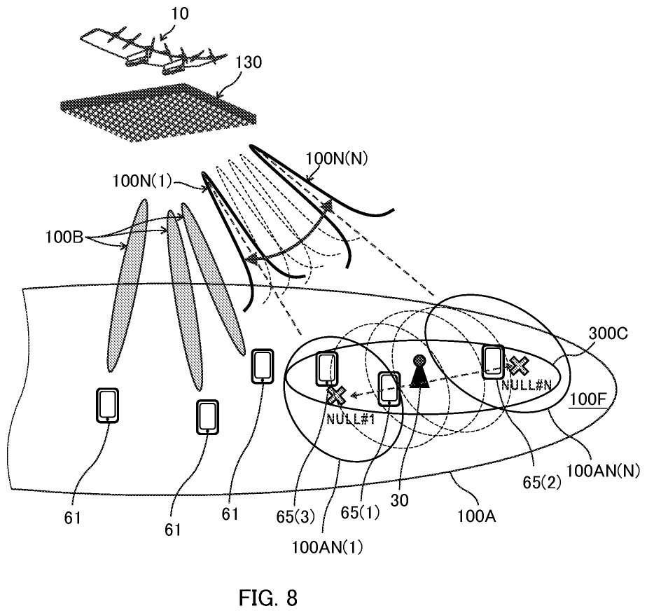

FIG. 8 is an illustration showing an example of null sweeping for changing the position of the null 100N of the beamforming formed from the HAPS 10 toward the terrestrial cell 300C, according to the embodiment. In order to improve the overall communication quality (for example, SINR) of the terrestrial cell 300C, in the present embodiment, a null sweeping is performed, in which the position of the null 100N of the directional beam formed from the array antenna 130 of the HAPS 10 toward the terrestrial cell 300C is changed for each radio resource, as shown in FIG. 8. This suppresses (reduces) an interference to each downlink communication of UEs 65(1) to 65(3) at each of the center part and cell edges of the terrestrial cell 300C.

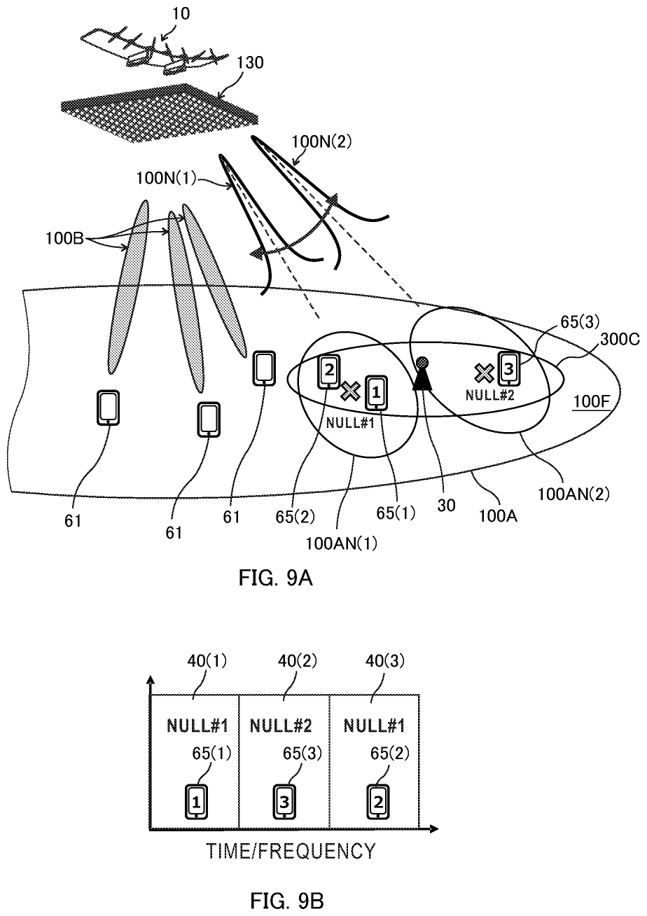

FIG. 9A is an illustration showing an example of null sweeping in the case of forming two nulls by switching between them for each radio resource from the HAPS 10 toward the terrestrial cell 300C, according to the embodiment. FIG. 9B is an illustration showing an example of a relationship between radio resources 40(1) to 40(3) of user scheduling, the null #1 point and the null #2 point, and the terrestrial cell user's UEs (terminal apparatuses) 65(1) to 65(3), in the null sweeping. The plural radio resources 40(1) to 40(3) differ from one another in time, frequency, or both time and frequency. In the examples of FIGS. 9A and 9B, in the radio resource 40(1) in which the HAPS 10 forms the null 100N(1) of the directional beam toward the null #1 point, the terrestrial-cell base station 30 allocates the UE 65(1). Further, in the radio resource 40(2) in which the HAPS 10 forms the null 100N(2) of the directional beam toward the null #2 point, the terrestrial-cell base station 30 allocates the UE 65(3). Furthermore, in the radio resource 40(3) in which the HAPS 10 forms the null 100N(1) of the directional beam toward the null #1 point, the terrestrial-cell base station 30 allocates the UE 65(2).

### [Exact Method]

In the system of the present embodiment, when the null sweeping by the HAPS 10 and the user scheduling by the terrestrial base station 30 are performed, it is necessary to estimate (calculate) the interference power in the UE 65 of the terrestrial cell user g located in the target terrestrial cell 300A. As a method for estimating the interference power, there is a method (hereinafter referred to as an “exact method”) that uses a transmission weight matrix

$$\begin{matrix}[ Mathematical 8 ] & \\ {W}_{r} ∈ {ℂ}^{{N}_{t} \times {N}_{u}} & \end{matrix}$$

applied to the array antenna 130 of the HAPS 10 and a propagation path response

$$\begin{matrix}[ Mathematical 9 ] & \\ {h}_{g} ∈ {ℂ}^{1 \times {N}_{t}} & \end{matrix}$$

between the array antenna 130 of the HAPS 10 and the terrestrial cell user g (UE65). Herein, the transmission weight matrix Wr is expressed as a product of a precoding matrix and a transmission-power control matrix. Furthermore, Nt is the number of elements of the array antenna (service link antenna) 130 of the HAPS 10, and Nu is the spatial multiplexing number (the number of HAPS users).

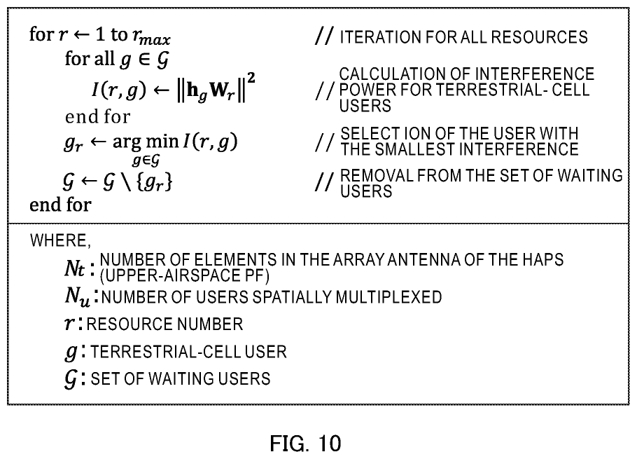

FIG. 10 is an illustration showing an example of a user scheduling algorithm (greedy method-like algorithm) in the case of the exact method for estimating the interference power of UE 65 of the terrestrial cell user g using the transmission weight matrix Wr to be applied to the array antenna 130 for service link of the HAPS 10, according to the embodiment. In the example of FIG. 10, the greedy method can sequentially select a user g that minimizes the interference power when the user is allocated to a certain resource r.

In the example of the user scheduling algorithm of FIG. 10, first, an initialization process is performed, which includes setting of a first set of user numbers g of terminal apparatuses of plural (Nu) unallocated users and setting of a second set for plural (Nr=rₘₐₓ) radio resources to be processed by the greedy method in order of resource numbers r. Next, in order from the first (r=1) to the Nr-th (r=rₘₐₓ) of the resource numbers r of the second set, the r-th resource number r in the second set is set as the resource number r of a user allocation target, and the following processes are performed for the terrestrial cell user g, which are the process of calculating the interference power I (r, g) of the terrestrial cell user g from the HAPS 10 in the case of allocating the radio resource of resource number r, using the following equation (10), the process of allocating the terrestrial cell user g with the smallest interference power as the user number gr to be allocated to the resource number r, and the process of removing the user number g, for which the allocation is confirmed, from the first set.

Thereafter, the user scheduling algorithm is executed repeatedly until the allocations of radio resources of all remaining users are completed. This completes the allocations of radio resources to all terrestrial-base station users (terrestrial cell users) located in the terrestrial cell 300C.

In the user scheduling algorithm of FIG. 10, the terrestrial base station 30 needs to estimate (calculate) the interference power I(r, g) from the HAPS 10 to the terrestrial cell user g (UE 65) for each radio resource (time, frequency) as shown in the following equation (10).

$$\begin{matrix}[ Mathematical 10 ] & \\ I ( r , g ) = {‖ {h}_{g} {W}_{r} ‖}^{2} & ( 10 )\end{matrix}$$

However, the terrestrial base station 30 cannot estimate the interference power by itself. For example, the propagation path response hg between the array antenna 130 of HAPS 10 and the terrestrial cell user g (UE 65) included in the above equation (10) can be theoretically calculated by assuming a propagation environment (model) based on the location information on the terrestrial cell user g (UE 65) and information notified from the HAPS 10. The notification information from the HAPS 10, which is necessary for estimating the propagation path response hg, is, for example, information on the specifications of the array antenna 130 of the HAPS 10, and information on the position and attitude of the HAPS airframe that is periodically notified from the HAPS 10, and the number of parameters that need to be notified from the HAPS 10 is small.

In addition, since the transmission weight matrix Wr applied to the array antenna 130 of the HAPS 10, which is included in the above equation (10), is known only by the HAPS 10 side, the transmission weight matrix Wr is notified from the HAPS 10 to the terrestrial base station 30. Although this transmission weight matrix Wr may be simply notified, the amount of data for the parameters (matrix elements) that need to be notified becomes enormous. For example, in the case that the number of elements Nt of the array antenna 130 is several hundreds and the number of user multiplexes Nu is several tens, the parameters (matrix elements) of the notified transmission weight matrix Wr are several thousands of complex numbers. Furthermore, since the transmission weight matrix Wr changes for each radio (time, frequency) resource, the transmission weight matrix Wr needs to be constantly updated.

### [Interference Model Method]

As described above, in the case that the interference power in the UE 65 of the terrestrial cell user g used in the null sweeping is estimated by the exact method, the amount of information on parameters (elements of the transmission weight matrix) notified from the HAPS 10 to the terrestrial base station 30 becomes enormous. In order to reduce the amount of control information notified from the HAPS 10 to the terrestrial base station 30 and shared between the HAPS 10 and the terrestrial base station 30, as an interference estimation method in the present embodiment, as shown below, an interference estimation method may be used, in which the terrestrial base station 30 estimates an interference using location information on terrestrial cell users and the small number of parameters, based on an interference model of modelling an interference from the HAPS (upper airspace PF) 10 to terrestrial cell users around the null. Then, by applying the interference estimation based on this interference model, the amount of control information notified from the HAPS (upper airspace PF) 10 to the terrestrial base station 30 of the terrestrial system may be reduced, and a user scheduling for each radio resource for terrestrial cell users may be performed using a scheduling method in the terrestrial base station 30 of the terrestrial system in consideration of the null formed by the HAPS (upper airspace PF) 10.

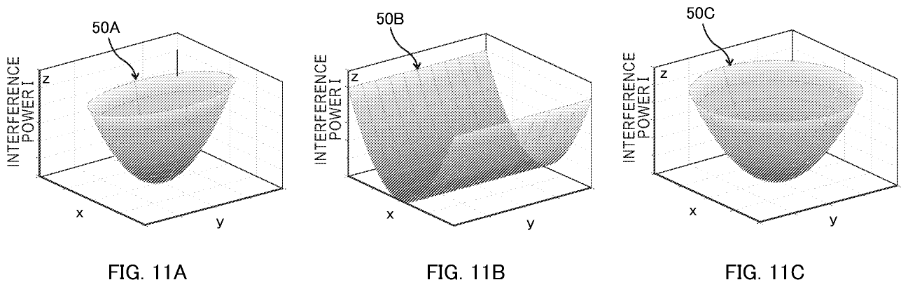

Each of FIGS. 11A, 11B and 11C is an illustration showing an example of a model of interference power distribution that models the spatial distribution of interference power I from the HAPS 10 centered on the null point of the terrestrial cell 300A, according to the embodiment. The z-axis in the figure indicates the interference power I received from the HAPS 10, and the x-axis and y-axis indicate coordinates in the planar direction centered on the null point in the terrestrial cell.

An interference model 50A in FIG. 11A is an example of an interference model of elliptical paraboloid type in which the interference power I is minimized at the null point and the contour line of the interference power I has an elliptical shape. An interference model 50B in FIG. 11B is an example of an interference model of parabolic type in which the interference power I is constant in the y-axis direction and the distribution shape of the interference power I in the z-x plane direction is a parabola. An interference model 50C in FIG. 11C is an example of an interference model of rotating paraboloid type in which the interference power I is minimized at the null point, the contour line of the interference power I has a circular shape, and the distribution shape of the interference power I in the vertical plane (plane including the z-axis) direction is a parabola.

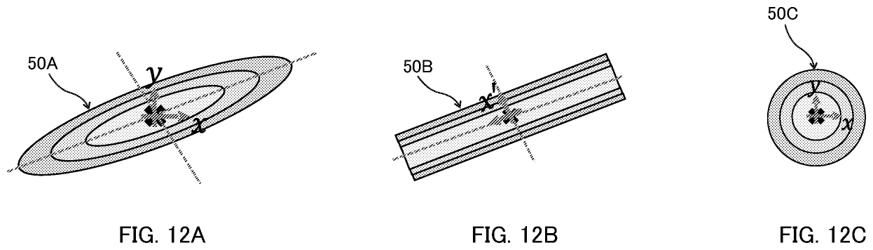

Each of FIGS. 12A, 12B and 12C is an illustration showing two-dimensional representations of the relationship between the contour lines of the interference power I and the coordinates in the interference estimation methods A, B and C using the interference models of FIGS. 11A, 11B and 11C. The solid lines in the figure are contour lines of the interference power I, and the difference in image density represents the magnitude of the interference power I. The position marked with “x” in the figure is a null point of the directional beam formed by the HAPS 10.

### [Interference Estimation Method A]

In the interference estimation method A, an interference power I_{modelA} from the HAPS 10 is calculated and estimated using the following equation (11) based on the interference model of elliptical paraboloid type 50A in FIGS. 11A and 12A.

$$\begin{matrix}[ Mathematical 11 ] & \\ {I}_{model A} ( r , g ) = {a}_{r} {x}_{g}^{2} + {b}_{r} {x}_{g} {y}_{g} + {c}_{r} {y}_{g}^{2} & ( 11 )\end{matrix}$$

The interference estimation method A can be easily extended to the higher-order terms, such as the second order or higher. In addition, since the transmission weight matrix is not required for the interference estimation in the terrestrial base station 30, it is possible to reduce the amount of control information notified from the HAPS 10 to the terrestrial base station 30. Furthermore, the terrestrial base station 30 does not need to estimate the propagation path response hg between the HAPS 10 and the terrestrial cell user.

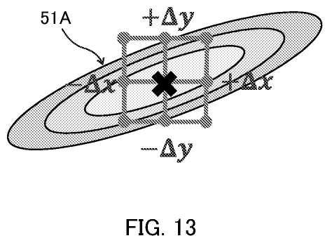

The coefficients aᵣ, bᵣ and cᵣ included in the above equation (11) as parameters for interference estimation differ for each null formed toward the terrestrial cell. The coefficients aᵣ, bᵣ and cᵣ can be calculated solely by the HAPS (upper airspace PF) 10 based on the theoretically calculated propagation path vector and the transmission weight to be applied to the target radio resource. For example, the coefficients aᵣ, bᵣ and cᵣ can be determined for each radio resource r by determining the interference power I at eight points that are located at predetermined distances Δx and Δy away from the null point shown in FIG. 13 using the theoretical formula shown in the following formula (12), and applying the values of the interference power I at the eight points to the following equations (13), (14) and (15).

$$\begin{matrix}[ Mathematical 12 ] & \\ I ( r ; x , y ) = {‖ h ( x , y ) {W}_{r} ‖}^{2} & ( 12 )\end{matrix}$$

$$\begin{matrix}[ Mathematical 13 ] & \\ {a}_{r} = \frac{I ( r ; + Δ x , 0 ) + I ( r ; - Δ x , 0 )}{2 {( Δ x )}^{2}} & ( 13 )\end{matrix}$$

$$\begin{matrix}[ Mathematical 14 ] & \\ {b}_{r} = \frac{I ( r ; + Δ x , + Δ y ) - I ( r ; + Δ x , - Δ y ) - I ( r ; - Δ x , + Δ y ) + I ( r ; - Δ x , - Δ y )}{4 Δ x Δ y} & ( 14 )\end{matrix}$$

$$\begin{matrix}[ Mathematical 15 ] & \\ {C}_{r} = \frac{I ( r ; 0 , + Δ y ) + I ( r ; 0 , - Δ y )}{2 {( Δ y )}^{2}} & ( 15 )\end{matrix}$$

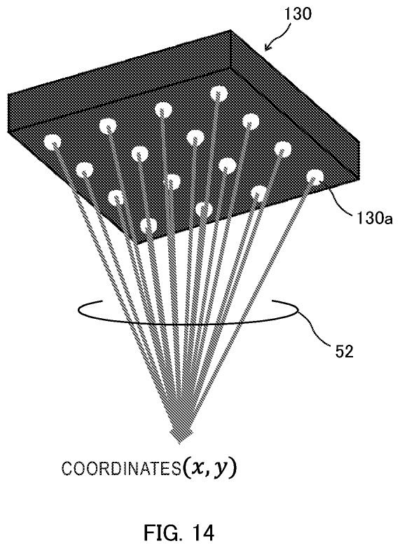

FIG. 14 is an illustration showing an example of a propagation path vector 52 between each element of the array antenna 130 for service link of the HAPS 10 and the target point of the terrestrial cell 300A, which is used to determine the coefficients aᵣ, bᵣ and cᵣ. In FIG. 14, the propagation path response hₙ (x, y) between each element n (130a) of the array antenna 130 and a point (x, y) to be calculated can be calculated by the following equation (16).

$$\begin{matrix}[ Mathematical 16 ] & \\ {h}_{n} ( x , y ) = {p}_{n} {d}_{n} {g}_{n} ( \begin{matrix}free space propagation loss : {p}_{n} = {( \frac{4 π}{λ} {D}_{n} )}^{- 1} & λ : wavelength \\ & {D}_{n} : path length \\ phase rotation amount : {d}_{n} = {e}^{j \frac{2 π}{λ} {D}_{n}} & f ( {θ}_{n} , {ϕ}_{n} ) : directivity function \\ & {θ}_{n} : elevation angle \\ gain of element : {g}_{n} = f ( {θ}_{n} , {ϕ}_{n} ) & {ϕ}_{n} : azimuth angle\end{matrix} ) & ( 16 )\end{matrix}$$

The path length Dn, the elevation angle θn and the azimuth angle on in the above equation (16) can be calculated from the coordinates (x, y) of the point to be calculated, the position and attitude of the airframe of the HAPS 10, the configuration of the array antenna 130, and so on.

By combining the propagation path responses hₙ (x, y) calculated for each element n (130a) of the array antenna 130, the propagation path vector h (x, y) of the following equation (17) can be obtained.

$$[ Mathematical 17 ]$$

$$h ( x , y ) = [ \begin{matrix}{h}_{1} & {h}_{2} & ⋯ & {h}_{{N}_{t}}\end{matrix} ] \qquad ( 17 )$$

### [Interference Estimation Method B]

In the interference estimation method B, an interference power I_{modelB} from the HAPS 10 is calculated and estimated using the following equation (18) based on the interference model of parabolic type 50B of FIGS. 11B and 12B.

$$[ Mathematical 18 ]$$

$${I}_{model B} ( r , g ) = {a}_{r}^{′} {x}_{g}^{′2} = {{a}_{r}^{′} ( cos ( {ϕ}_{r} ) {x}_{g} - sin ( {ϕ}_{r} ) {y}_{g} )}^{2} \qquad ( 18 )$$

In the interference estimation method B, the coefficients of the interference estimation method A mentioned above are restricted to bᵣ=0 and cᵣ=0. In the interference model 50B used in the interference estimation method B, since the x-axis is rotated by a predetermined rotation angle or as described later, x_{g}≠x_{g}′ in general.

In the interference estimation method B, similarly to the above-mentioned interference estimation method A, it is easy to extend to the higher-order terms of the second order or higher. Furthermore, since no transmission weight matrix is required for the interference estimation in the terrestrial base station 30, the amount of control information (amount of control parameter information) notified from the HAPS 10 to the terrestrial base station 30 can be reduced. In particular, since the number of parameters for the interference estimation in the calculation formula is fewer than that in the interference estimation method A, that is, only the coefficient aᵣ′ and the rotation angle or for coordinate rotation, the amount of control information notified to the terrestrial base station 30 can be further reduced. Furthermore, the terrestrial base station 30 does not need to estimate the propagation path response h_{g} between the HAPS 10 and the terrestrial cell users.

The coefficient aᵣ′ and the rotation angle or included in the above equation (18) differ for each null formed toward the terrestrial cell, and can be calculated by the HAPS (upper airspace PF) 10 alone.

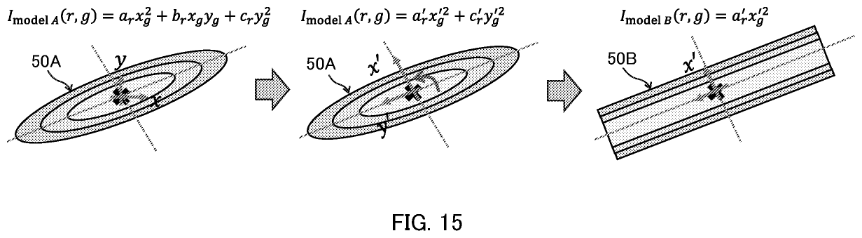

FIG. 15 is an illustration showing an example of a coefficient determination method for determining the coefficient aᵣ′ of a calculation formula for interference power in the interference estimation method B applicable to null sweeping, according to the embodiment. In FIG. 15, first, the coefficients aᵣ, bᵣ and cᵣ included in the equation (11) in the interference model 50A of the interference estimation method A mentioned above are calculated. Next, the orthogonal coordinate system is rotated by a rotation angle or so that the x-axis of coordinates coincides with the minor axis of the ellipse representing the contour lines of the interference power in the interference model 50A. Next, only the contribution of the minor axis of the ellipse representing the contour lines of the interference power is extracted, and the coefficient aᵣ′ as the parameter for interference estimation in the above-mentioned equation (18) is determined.

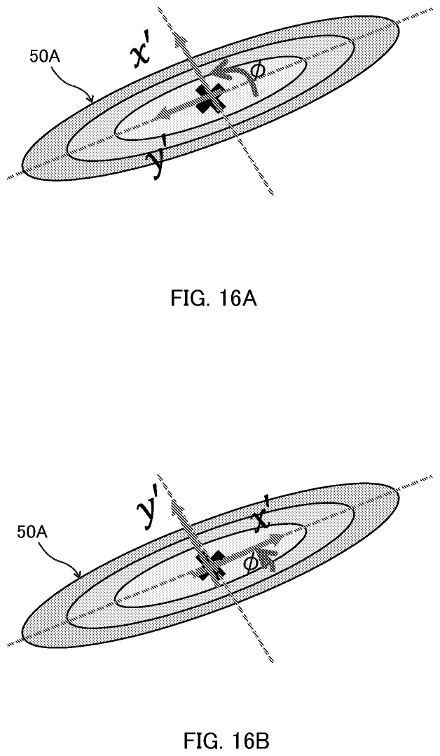

Each of FIGS. 16A and 16B is an illustration showing an example of rotation of coordinate axis in the coefficient determination method of the interference estimation method B. When the equation (11) for calculating the interference power I_{modelA} in the above-described interference estimation method A is written in matrix form, it becomes the following equation (19) (the subscripts r and g are omitted).

$$[ Mathematical 19 ]$$

$${I}_{model A} = {ax}^{2} + bxy + {cy}^{2} = ( \begin{matrix}x & y\end{matrix} ) ( \begin{matrix}a & \frac{b}{2} \\ \frac{b}{2} & c\end{matrix} ) ( \begin{matrix}x \\ y\end{matrix} ) \qquad ( 19 )$$

Herein, when a diagonalization is performed using a rotation matrix R shown in the following equations (20) and (21), the interference power I_{modelA} can be expressed by the following equation (22).

$$[ Mathematical 20 ]$$

$$R = ( \begin{matrix}+ cos ϕ & - sin ϕ \\ + sin ϕ & + cos ϕ\end{matrix} ) ← ϕ = \frac{1}{2} atan ( - b / ( a - c ) ) \qquad ( 20 )$$

$$[ Mathematical 21 ]$$

$$( \begin{matrix}{x}^{′} \\ {y}^{′}\end{matrix} ) = R ( \begin{matrix}x \\ y\end{matrix} ) = ( \begin{matrix}cos ( ϕ ) x - sin ( ϕ ) y \\ sin ( ϕ ) x + cos ( ϕ ) y\end{matrix} ) \qquad ( 21 )$$

$$[ Mathematical 22 ]$$

$$\begin{matrix}{I}_{model A} ( x , y ) = ( \begin{matrix}x & y\end{matrix} ) {R}^{T} R ( \begin{matrix}a & \frac{b}{2} \\ \frac{b}{2} & c\end{matrix} ) {R}^{T} R ( \begin{matrix}x \\ y\end{matrix} ) \\ = ( \begin{matrix}{x}^{′} & {y}^{′} ) ( \begin{matrix}{a}^{′} & 0 \\ 0 & {c}^{′}\end{matrix} ) ( \begin{matrix}{x}^{′} \\ {y}^{′}\end{matrix} )\end{matrix} \\ = {a}^{′} {x}^{′2} + {c}^{′} {y}^{′2}\end{matrix} \qquad ( 22 )$$

In the above equation (22), if a′≥c′, since the x′ axis after rotation coincides with the minor axis as shown in FIG. 16A, c′=0 can be ignored in the equation (22) to obtain the above-mentioned equation (18).

In the above equation (22), if a′<c′, since the x′ axis after rotation may not coincide with the minor axis as shown in FIG. 16B, by substituting φ+90° for φ and c′ for a′, the above-mentioned equation (18) can be obtained.

### [Interference Estimation Method C]

In the interference estimation method C, an interference power I_{modelC} from the HAPS 10 is calculated and estimated using the following equation (23) based on the interference model of rotating paraboloid type 50C in FIGS. 11C and 12C.

$$[ Mathematical 23 ]$$

$${I}_{model C} ( r , g ) = {a}_{r}^{′′} ( {x}_{g}^{2} + {y}_{g}^{2} ) \qquad ( 23 )$$

In the interference estimation method C, the coefficients of the interference estimation method A mentioned above are restricted to aᵣ=cᵣ and bᵣ=0. The interference power I_{modelC} calculated by the interference model 50C used in the interference estimation method C increases with the distance from the null point.

In the interference estimation method C, similarly to the above-mentioned interference estimation method A, it is easy to extend to the higher-order terms of the second order or higher. Furthermore, since no transmission weight matrix is required for interference estimation in the terrestrial base station 30, the amount of control information notified from the HAPS 10 to the terrestrial base station 30 can be reduced. In particular, since the number of coefficients in the calculation formula is smaller than that in the interference estimation method A, that is, there is only the coefficient aᵣ″, the amount of control information notified to the terrestrial base station 30 can be further reduced. Furthermore, the terrestrial base station 30 does not need to estimate the propagation path response h_{g} between the HAPS 10 and the terrestrial cell users.

The coefficient aᵣ″ included in the above equation (23) differs for each null formed toward the terrestrial cell, and can be calculated by the HAPS (upper airspace PF) 10 alone. Moreover, in the interference estimation method C, unlike the above-described interference estimation method B, since the interference model 50C is rotationally symmetric, there is no need to notify the rotation angle φᵣ.

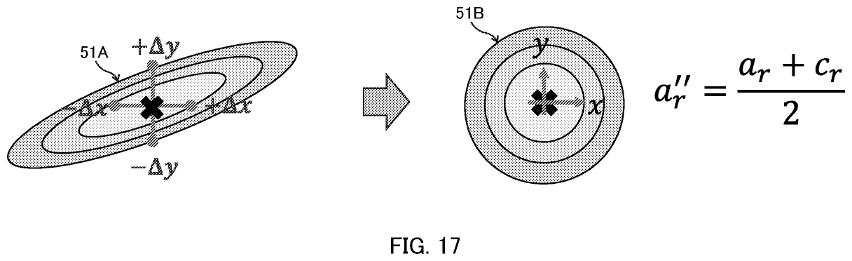

FIG. 17 is an illustration showing an example of a coefficient determination method for determining the coefficient aᵣ″ of the calculation formula for interference power in the interference estimation method C applicable to null sweeping, according to the embodiment. In FIG. 17, first, the coefficients aᵣ and cᵣ included in the equation (11) in the interference model 50A of the interference estimation method B mentioned above are calculated. Next, the coefficient aᵣ″ serving as a parameter for interference estimation in the equation (23) of the interference model 50C is determined from an average value (or a median value) of the coefficients aᵣ and cᵣ obtained by statistically processing the coefficients aᵣ and cᵣ.

### [Overall System for Each Interference Estimation Method]

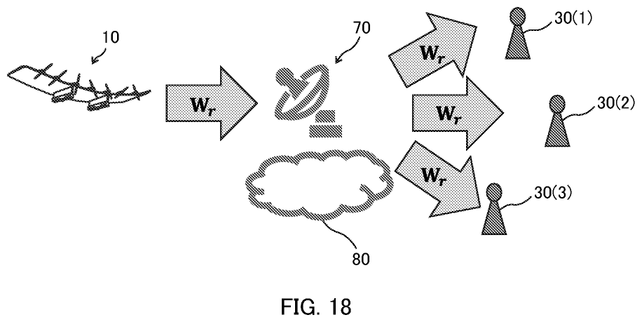

FIG. 18 is an illustration showing an example of a flow of information in the entire system in the case that a user scheduling method using interference power estimated by the exact method using the transmission weight matrix Wr is applied, according to the embodiment. In the case of the exact method, the transmission weight matrix Wr calculated for each radio resource in the HAPS (upper airspace PF) 10 is notified to each of the plural terrestrial base stations 30(1) to 30(3) located in the wide-area cell 100C via the gateway station 70 and the mobile communication network 80, and is used for estimating the interference power I (r, g) using the equation (11) mentioned above. Herein, the information on the transmission weight matrix Wr notified to the terrestrial base stations 30(1) to 30(3) may be information on the transmission weight matrix Wr consisting of an average value or a median value obtained by statistically processing plural elements of the transmission weight matrices Wr.

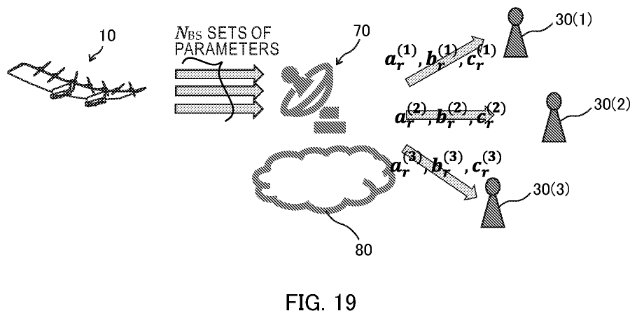

FIG. 19 is an illustration showing an example of a flow of information in the entire system in the case that a user scheduling method using interference power estimated by the interference estimation method A using the interference model is applied, according to the embodiment. In the case of the interference estimation method A, the N_{BS} (number of terrestrial base stations) sets of the coefficients aᵣ⁽¹⁾, bᵣ⁽¹⁾, cᵣ⁽¹⁾, aᵣ⁽²⁾, bᵣ⁽²⁾, cᵣ⁽²⁾, aᵣ⁽³⁾, bᵣ⁽³⁾ and cᵣ⁽³⁾, which are calculated for each radio resource for each of the terrestrial base stations 30(1) to 30(3) by the HAPS (upper airspace PF) 10, are notified to each of the plural terrestrial base stations 30(1) to 30(3) located in the wide-area cell 100C via the gateway station 70 and the mobile communication network 80, and are used for estimating the interference power I_{modelA} using the equation (11) mentioned above. Herein, the coefficients as the parameters for interference estimation notified to the terrestrial base stations 30(1) to 30(3) may be information such as an average value or a median value of the coefficients obtained by statistically processing the plural coefficients.

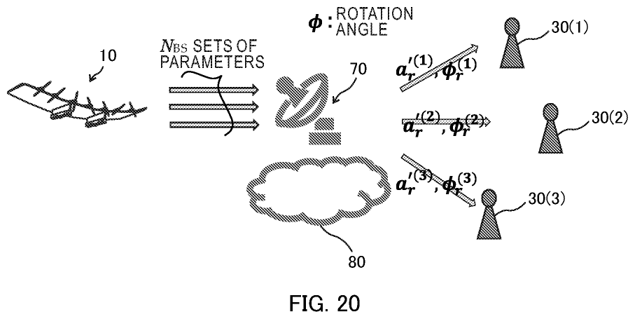

FIG. 20 is an illustration showing an example of a flow of information in the entire system in the case that a user scheduling method using interference power estimated by the interference estimation method B using the interference model is applied, according to the embodiment. In the case of the interference estimation method B, the N_{BS} (number of terrestrial base stations) sets of the coefficient aᵣ′⁽¹⁾ and the rotation angle φᵣ⁽¹⁾, a_{r′}⁽²⁾ and the rotation angle φᵣ⁽²⁾, and aᵣ′⁽³⁾ and the rotation angle φᵣ⁽³⁾, which are calculated for each radio resource for each of the terrestrial base stations 30(1) to 30(3) by the HAPS (upper airspace PF) 10, are notified to each of the plural terrestrial base stations 30(1) to 30(3) located in the wide-area cell 100C via the gateway station 70 and the mobile communication network 80, and are used for estimating the interference power I_{modelB} by the equation (18) mentioned above. Herein, the coefficients and rotation angles as the parameters for interference estimation notified to the terrestrial base stations 30(1) to 30(3) may be information such as an average value or a median value of the coefficients and rotation angles obtained by statistically processing the plural coefficients and rotation angles.

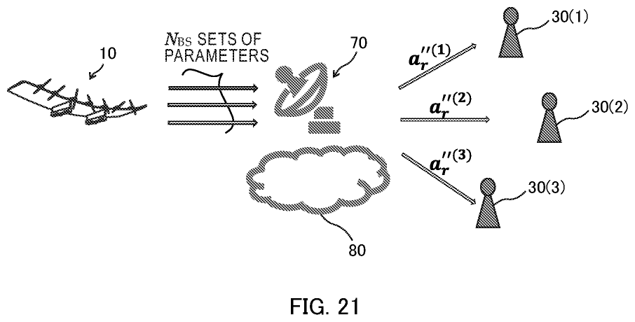

FIG. 21 is an illustration showing an example of a flow of information in the entire system in the case that a user scheduling method using interference power estimated by the interference estimation method C using the interference model is applied, according to the embodiment. In the case of interference estimation method C, the N_{BS} (number of terrestrial base stations) sets of the coefficients aᵣ″⁽¹⁾, aᵣ″⁽²⁾ and aᵣ″⁽³⁾, which are calculated for each radio resource for each of the terrestrial base stations 30(1) to 30(3) by the HAPS (upper airspace PF) 10, are notified to each of the plural terrestrial base stations 30(1) to 30(3) located in the wide-area cell 100C via the gateway station 70 and the mobile communication network 80, and are used for estimating the interference power I_{modelC} by the equation (23) mentioned above. Herein, the coefficients as parameters for interference estimation notified to the terrestrial base stations 30(1) to 30(3) may be information such as the average value or the median value of the coefficients obtained by statistically processing the plural coefficients.

### [Computer Simulation of Interference Power Estimation]

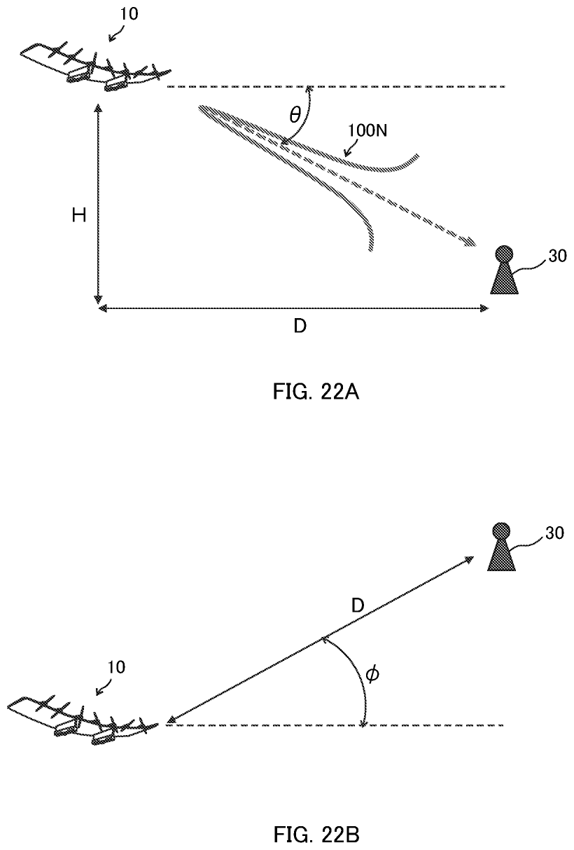

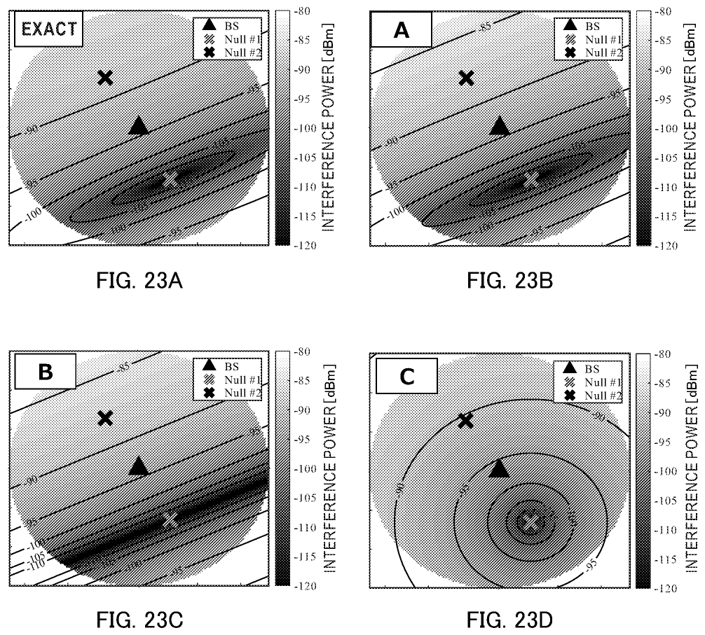

FIGS. 22A and 22B are illustrations showing setting conditions in an example of a computer simulation of the interference power estimation using each of the exact method, the interference estimation method A, the interference estimation method B and the interference estimation method C, according to the embodiment. In the computer simulation of the present example, as shown in the side-on view of FIG. 22A, the horizontal distance D (for example, 40 km) between the HAPS (upper airspace PF) 10 and the terrestrial base station 30 is twice the altitude H (for example, 20 km) of the HAPS 10, and as shown in the top-down view of FIG. 22B, the azimuth angle φ of the direction of the terrestrial base station 30 relative to the HAPS 10 is 30°. In the case that the terrestrial base station 30 is far from the HAPS 10 as in this setting condition, since the change in the downward elevation/depression angle θ as seen from the HAPS 10 in the upper airspace is small, the null area 100AN tends to extend in the radial direction as shown in FIGS. 23A, 23B and 23C.

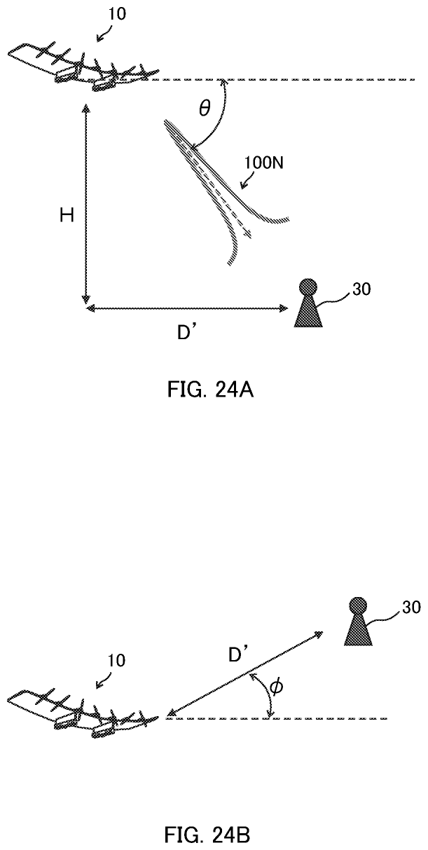

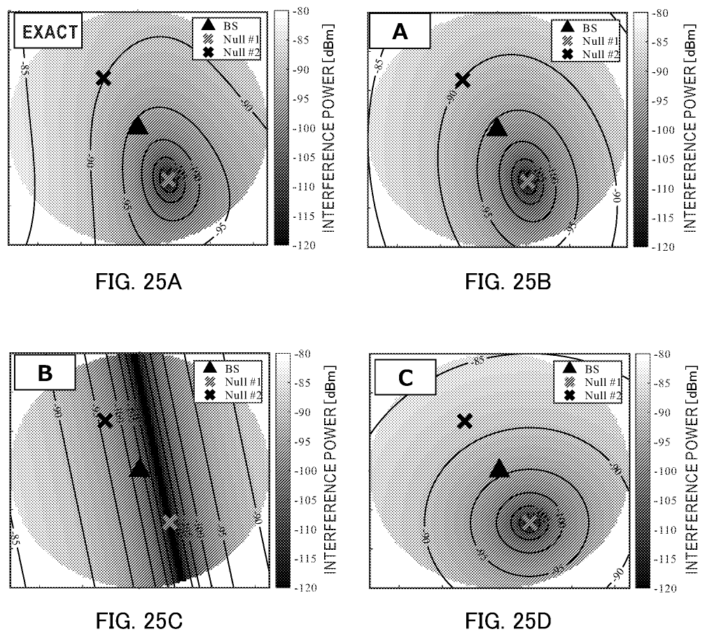

FIGS. 24A and 24B are illustrations showing setting conditions in another example of a computer simulation of the interference power estimation using each of the exact method, the interference estimation method A, the interference estimation method B and the interference estimation method C, according to the embodiment. In the computer simulation of the present example, as shown in the side-on view of FIG. 24A, the horizontal distance D′ (for example, 20 km) between the HAPS (upper airspace PF) 10 and the terrestrial base station 30 is equal to the altitude H (for example, 20 km) of the HAPS 10, and as shown in the top-down view of FIG. 24B, the azimuth angle φ of the direction of the terrestrial base station 30 relative to the HAPS 10 is 30°. In the case that the terrestrial base station 30 is close to the HAPS 10 as in this setting condition, since the change in the downward elevation/depression angle θ as seen from the HAPS 10 in the upper airspace is large, the null area 100AN tends to shrink in the radial direction compared to FIG. 23, as shown in FIGS. 25A, 25B and 25C.

### [User Scheduling Methods A-1, B-1, C-1]

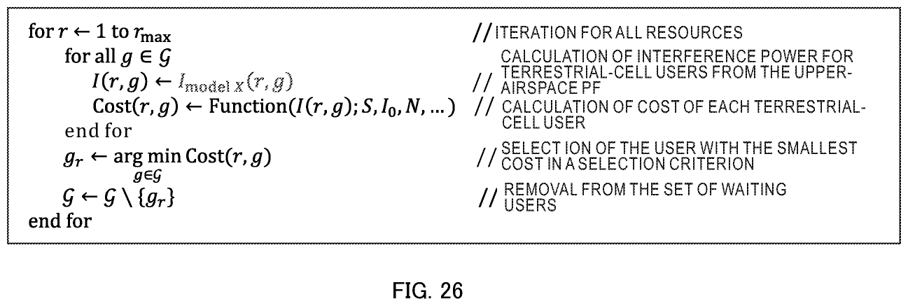

FIG. 26 is an illustration showing an example of a common algorithm (greedy method-like algorithm) for user scheduling methods A-1, B-1 and C-1, to which the interference estimation method A, the interference estimation method B and the interference estimation method C based on the interference model are applied, according to the embodiment. It is noted that in FIG. 26, the description of the parts common to the above-mentioned FIG. 10 is omitted.

In the user scheduling methods A-1, B-1 and C-1 of the present example, the interference power calculated using the interference estimation method A, the interference estimation method B, or the interference estimation method C is used as the interference power I (r, g) in the user schedule algorithm. In particular, the above-mentioned interference power I_{modelA} calculated using the equation (11), the interference power I_{modelB} calculated using the equation (18), or the interference power I_{modelC} calculated using the equation (23) is used as the interference power I (r, g) in the user scheduling algorithm.

Further, in the user scheduling methods A-1, B-1 and C-1 of the present example, the above-mentioned interference power I_{modelX} (for example, I_{modelA}, I_{modelB}, or I_{modelC}) is combined with information that can be obtained or calculated by the terrestrial base station 30 (for example, desired signal power S, inter-cell or inter-sector interference power I₀, noise power N, etc.). For example, as a function of a selection criterion used for determining the user selection, the SINR, which is a function of desired signal power S, inter-cell or inter-sector interference power I₀, noise power N, etc., shown in the following equation (24), can be used.

$$[ Mathematical 24 ]$$

$$SINR = S / ( {I}_{model X} + {I}_{0} + N ) \qquad ( 24 )$$

In the user scheduling methods A-1, B-1 and C-1 of the present example, with respect to a conversion from the location information on terrestrial cell user g to coordinates (x_{g}, Vg) on the interference model, if the location of the null formed by each radio resource is shared in advance between the HAPS 10 and the terrestrial system (terrestrial base station) 30, there is no need to notify the terrestrial base station 30 for each radio resource. Moreover, the null formed for each terrestrial cell 300A is one null per radio resource (time/frequency resource).

In FIG. 26, after performing the above-mentioned initialization process, the r-th resource number r in the second set is set as the resource number r to be allocated to users in order from the first (r=1) to the Nr-th (r=rₘₐₓ) of the resource number r in the second set, and for all terrestrial cell users g included in the first set, the interference power I_{modelX} of the terrestrial cell user g from the HAPS 10 when allocating the radio resource of resource number r is calculated using the above-mentioned equation (11), equation (18) or equation (23). Then, the following processes are performed, which are a process of calculating a cost (Cost (r, g)) as a metric value for determination in a user selection criterion, a process of allocating the terrestrial cell user g for which the cost is smallest as the user number gr to be allocated to the resource number r, and a process of removing the user number gr for which the allocation is confirmed, from the first set.

Herein, as the cost (Cost (r, g)), for example, the inverse of the SINR in the above-mentioned equation (24), which is a function of the desired signal power S, the inter-cell or inter-sector interference power I₀, the noise power N, etc., can be used.

Thereafter, the above user scheduling algorithm is executed repeatedly until the resources of all remaining users are allocated. This completes the allocation of all terrestrial-base station users (terrestrial cell users) located in the terrestrial cell 300C, to the resources.

It is noted that, in the user scheduling method of the present embodiment, a normalized value of the interference power may be used, which is defined so that the parameters can be further reduced in each of the interference models, as shown below.

### [User Scheduling Method A-2]

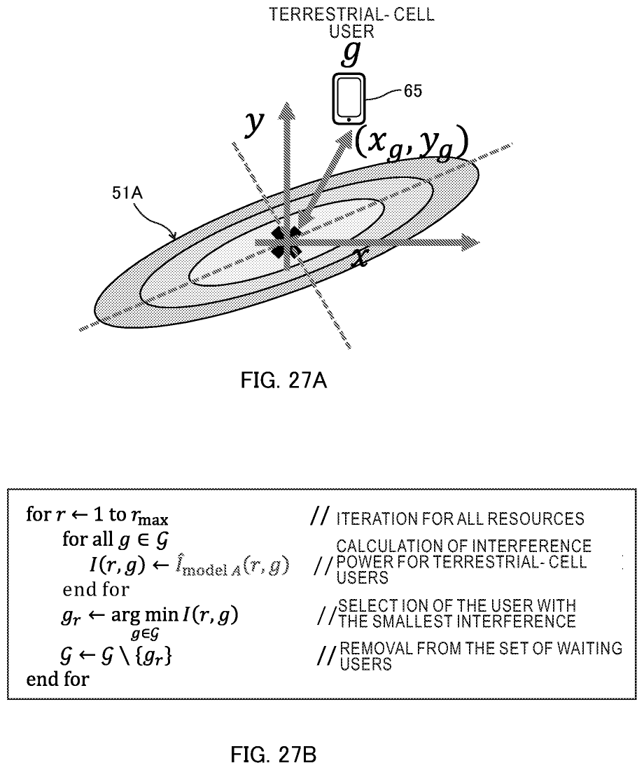

FIG. 27A is an illustration showing an example of the relationship between the contour lines of interference power and coordinates in interference estimation method A to be combined with a reduction in the number of parameters. FIG. 27B is an illustration showing an example of an algorithm (greedy method-like algorithm) of the user scheduling method A-2 to be combined with the interference estimation method A and a reduction in the number of parameters. It is noted that in FIG. 27B, the description of the parts common to the above-mentioned FIG. 10 and FIG. 26 is omitted.

In the user scheduling method A-2 of the present example, focusing on the fact that the magnitude relationship does not change even if the interference power calculated in the interference model shown in FIG. 27A is divided by a constant, and that the parameters to be notified can be eliminated if only comparing the magnitudes, the normalized value of the interference power calculated by dividing the above-mentioned equation (11) by a constant (for example, coefficients aᵣ, bᵣ or cᵣ) is used for determining the user selection. In the present example, as an example, the normalized value of the interference power calculated by the following equation (25) obtained by dividing the above equation (11) by the coefficient aᵣ of the x-squared term is used for determining the user selection. Moreover, in the calculation formula of the equation (25), since the coefficient of the x-squared term is fixed to 1, the values of the remaining two coefficients bᵣ/aᵣ and cᵣ/aᵣ are notified to the terrestrial base station 30 as information on control parameters (parameters for interference estimation). It is noted that, as the normalized value of the interference power, the value obtained by dividing the above-mentioned equation (11) by the coefficient bᵣ or cᵣ may be used.

$$[ Mathematical 25 ]$$

$${\hat{I}}_{model A} ( r , g ) = {x}_{g}^{2} + \frac{{b}_{r}}{{a}_{r}} {x}_{g} {y}_{g} + \frac{{c}_{r}}{{a}_{r}} {y}_{g}^{2} \qquad ( 25 )$$

In the user scheduling method A-2 of the present example, regarding the conversion from the location information on the terrestrial cell user g to the coordinates (x_{g}, y_{g}) on the interference model, if the locations of the nulls formed by each radio resource are shared in advance between the HAPS 10 and the terrestrial system (terrestrial base station) 30, there is no need to notify the terrestrial base station 30 for each radio resource. Moreover, the null formed for each terrestrial cell 300A is one null per radio resource (time/frequency resource).

In FIG. 27B, after performing the above-mentioned initialization process, the r-th resource number r in the second set is set as the resource number r of the user allocation target in order from the first (r=1) to the Nr-th (r=rₘₐₓ) resource number r in the second set. Then, for all terrestrial cell users g included in the first set, the following processes are performed, which are a process of calculating a normalized value of the interference power I_{modelA} (r, g) of the terrestrial cell user g from the HAPS 10 using the above-mentioned equation (25) when allocating the radio resource of the resource number r, a process of allocating the terrestrial cell user g having the smallest normalized value of the interference power I_{modelA} (r, g) as the user number gr to be allocated to the resource number r, and a process of removing the user number g, for which the allocation is confirmed, from the first set.

Thereafter, the above user scheduling algorithm is executed repeatedly until the allocations to resources of all remaining users are completed. This completes the allocation to resources of all terrestrial base station users (terrestrial cell users) located in the terrestrial cell 300C.

### [User Scheduling Method B-2]

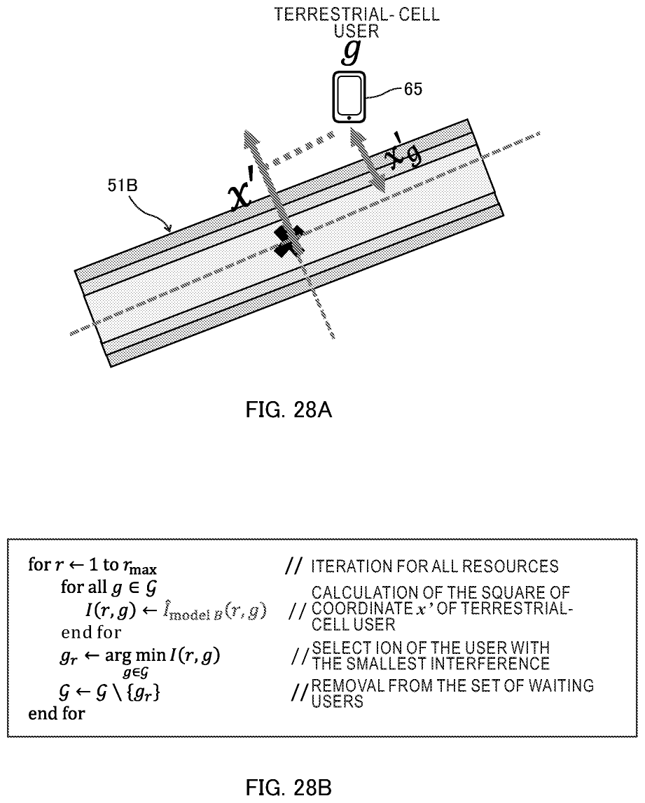

FIG. 28A is an illustration showing an example of the relationship between the contour lines of interference power and coordinates in interference estimation method B to be combined with a reduction in the number of parameters. FIG. 28B is an illustration showing an example of an algorithm (greedy method-like algorithm) of user scheduling method B-2 in which the interference estimation method B is combined with a reduction in the number of parameters. It is noted that in FIG. 28B, the description of the parts common to the above-mentioned FIG. 10 and FIG. 26 is omitted.

In the user scheduling method B-2 of the present example, focusing on the fact that the magnitude relationship does not change even if the interference power calculated in the interference model shown in FIG. 28A is divided by a constant, and that the parameters to be notified can be eliminated if only comparing the magnitudes, the normalized value of the interference power calculated by the following equation (26), obtained by dividing the above equation (18) by the coefficient aᵣ′ of the x′ squared term, is used to determine the user selection. Furthermore, in the calculation formula of the equation (26), since the terrestrial base station 30 can convert the coordinates of the terrestrial cell user g (UE) to x_{g}′, the value of the rotation angle or of the coordinates for each radio resource is notified to the terrestrial base station 30 as information on the control parameter (parameter for interference estimation).

$$[ Mathematical 26 ]$$

$${\hat{I}}_{model B} ( r , g ) = {x}_{g}^{′2} = {( cos ( {ϕ}_{r} ) {x}_{g} - sin ( {ϕ}_{r} ) {y}_{g} )}^{2} \qquad ( 26 )$$

In the user scheduling method B-2 of the present example, regarding the conversion from the location information on the terrestrial cell user g to the coordinates (x_{g}, y_{g}) on the interference model, if the locations of the nulls formed by each radio resource are shared in advance between the HAPS 10 and the terrestrial system (terrestrial base station) 30, there is no need to notify the terrestrial base station 30 for each radio resource. Moreover, the null formed for each terrestrial cell 300A is one null per radio resource (time/frequency resource).

In FIG. 28B, after performing the above-mentioned initialization process, the r-th resource number r in the second set is set as the resource number r of the user allocation target in order from the first (r=1) to the Nr-th (r=Imax) resource number r in the second set. Then, for all terrestrial cell users g included in the first set, the following processes are performed, which are a process of calculating a normalized value of the interference power I_{modelB} (r, g) of the terrestrial cell user g from the HAPS 10 using the above-mentioned equation (26) when allocating the radio resource of the resource number r, a process of allocating the terrestrial cell user g having the smallest normalized value of the interference power I_{modelB} (r, g) as the user number g, to be allocated to the resource number r, and a process of deleting the user number g, for which the allocation is confirmed, from the first set.

Thereafter, the above user scheduling algorithm is executed repeatedly until the allocations to resources of all remaining users are completed. This completes the allocation to resources of all terrestrial base station users (terrestrial cell users) located in the terrestrial cell 300C.

### [User Scheduling Method C-2]

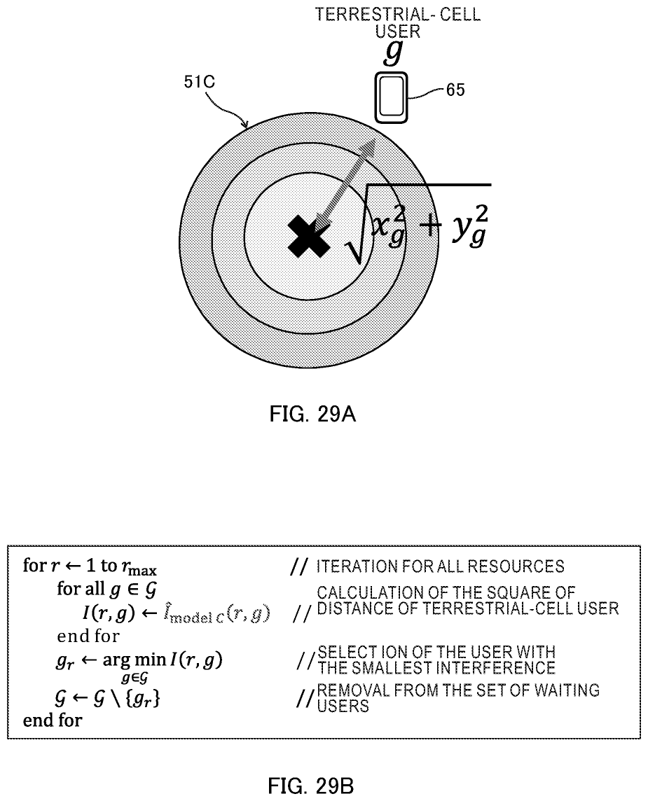

FIG. 29A is an illustration showing an example of the relationship between the contour lines of interference power and coordinates in interference estimation method C to be combined with a reduction in the number of parameters. FIG. 29B is an illustration showing an example of an algorithm (greedy method-like algorithm) of user scheduling method C-2 in which the interference estimation method C is combined with a reduction in the number of parameters. It is noted that in FIG. 29B, the description of the parts common to the above-mentioned FIG. 10 and FIG. 26 is omitted.

In the user scheduling method C-2 of the present example, focusing on the fact that the magnitude relationship does not change even if the interference power calculated in the interference model shown in FIG. 29A is divided by a constant, and that the parameters to be notified can be eliminated if only comparing the magnitudes, the normalized value of the interference power calculated by the following equation (27) obtained by dividing the above equation (23) by a coefficient aᵣ″ is used for determining the user selection. In addition, since the normalized value of the interference power in equation (27) can be calculated from the distance (coordinates x_{g}, y_{g}) from the null point of the terrestrial cell user g (UE), there is no control parameter information notified to the terrestrial base station 30.

$$[ Mathematical 27 ]$$

$${\hat{I}}_{model C} ( r , g ) = {x}_{g}^{2} + {y}_{g}^{2} \qquad ( 27 )$$

In the user scheduling method C-2 of the present example, regarding the conversion from the location information on the terrestrial cell user g to the coordinates (x_{g}, y_{g}) on the interference model, if the locations of nulls formed by each radio resource are shared in advance between the HAPS 10 and the terrestrial system (terrestrial base station) 30, there is no need to notify the terrestrial base station 30 of each radio resource. Moreover, the null formed for each terrestrial cell 300A is one null per radio resource (time/frequency resource).

In FIG. 29B, after performing the above-mentioned initialization process, the r-th resource number r of the second set is set as the resource number r of the user allocation target in order from the first (r=1) to the Nr-th (r=Imax) resource number r of the second set. Then, for all terrestrial cell users g included in the first set, the following processes are performed, which are a process of calculating a normalized value of the interference power I_{modelC} (r, g) of the terrestrial cell user g from the HAPS 10 using the above-mentioned equation (27) when allocating the radio resource of the resource number r, a process of allocating the terrestrial cell user g having the smallest normalized value of the interference power I_{modelC} (r, g) as the user number gr to be allocated to the resource number r, and a process of deleting the user number gr for which the allocation is confirmed, from the first set.

Thereafter, the above user scheduling algorithm is executed repeatedly until the allocations to resources of all remaining users are completed. This completes the allocation of resources to all terrestrial base station users (terrestrial cell users) located in the terrestrial cell 300C.

[Overall System Combining Interference Estimation Methods Using Each Interference Model with Parameter Reduction]

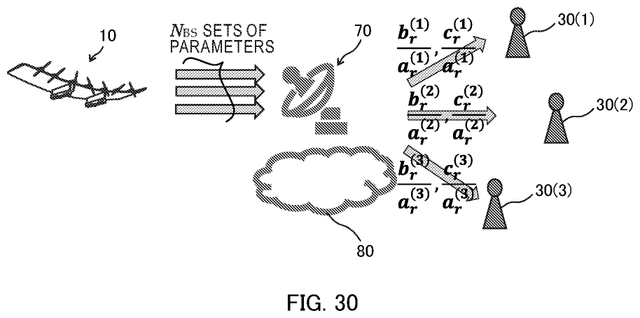

FIG. 30 is an illustration showing an example of a flow of control parameter information in the entire system in the case that the user scheduling method A-2 is applied, according to the embodiment. In the case of combining the interference estimation method A with the parameter reduction, the N_{BS} (number of terrestrial base stations) sets of the coefficients bᵣ⁽¹⁾/aᵣ⁽¹⁾, cᵣ⁽¹⁾/aᵣ⁽¹⁾, bᵣ⁽²⁾/aᵣ⁽²⁾, cᵣ⁽²⁾/aᵣ⁽²⁾, bᵣ⁽³⁾/aᵣ⁽³⁾ and cᵣ⁽³⁾/aᵣ⁽³⁾, which are calculated for each radio resource for each of the terrestrial base stations 30(1) to 30(3) by the HAPS (upper airspace PF) 10 are notified to each of the plural terrestrial base stations 30(1) to 30(3) located in the wide-area cell 100C via the gateway station 70 and the mobile communication network 80, and are used for estimating the interference power I_{modelA} (calculation of the normalized value) by the above-mentioned equation (25). Herein, the coefficients as the parameters for interference estimation notified to the terrestrial base stations 30(1) to 30(3) may be information such as the average value or the median value of the coefficients obtained by statistically processing the plural coefficients.

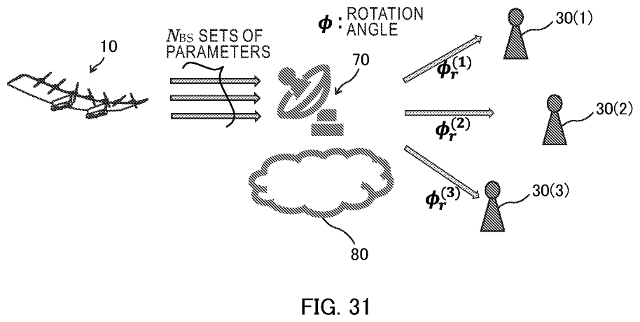

FIG. 31 is an illustration showing an example of a flow of control parameter information in the entire system in the case that the user scheduling method B-2 is applied, according to the embodiment. In the case of combining the interference estimation method B with the parameter reduction, the N_{BS} (number of terrestrial base stations) sets of the rotation angles φᵣ⁽¹⁾, φᵣ⁽²⁾ and φᵣ⁽³⁾, which are calculated for each radio resource for each of the terrestrial base stations 30(1) to 30(3) by the HAPS (upper airspace PF) 10, are notified to each of the plural terrestrial base stations 30(1) to 30(3) located in the wide-area cell 100C via the gateway station 70 and the mobile communication network 80, and are used for estimating the interference power I_{modelB} (calculation of the normalized value) by the above-mentioned equation (26). Herein, the rotation angle as the parameter for interference estimation notified to the terrestrial base stations 30(1) to 30(3) may be information such as an average value or a median value of the rotation angles obtained by statistically processing the plural rotation numbers.

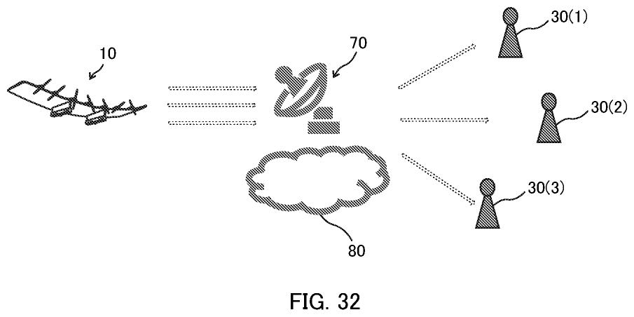

FIG. 32 is an illustration showing an example of a flow of control parameter information in the entire system in the case that the user scheduling method C-2 is applied, according to the embodiment. In the case of combining the interference estimation method C with the parameter reduction, there is no control parameter information notified from the HAPS (upper airspace PF) 10 to the terrestrial base stations 30(1) to 30(3).

Table 1 shows a comparison result between the exact method and the interference estimation methods A, B and C using the interference model. In Table 1, each of Nt and Nu is the number of antenna elements of the array antenna 130 in the HAPS (upper airspace PF) 10 and the number of spatially multiplexed users. N_{BS} is the number of terrestrial base stations 30 located in the wide-area cell 100C.

| | | INTERFERENCE ESTIMATION METHODS USING INTERFERENCE MODELS | | |
|---|---|---|---|---|
| | EXACT METHOD | A | B | C |
| ESTIMATED INTERFERENCE | \|\|h_{g}Wᵣ\|\|² | ${a}_{r} {x}_{g}^{2} + {b}_{r} {x}_{g} {y}_{g} + {c}_{r} {y}_{g}^{2}$ | ${a}_{r}^{′} {x}_{g}^{′2}$ | ${a}_{r}^{″} ( {x}_{g}^{2} + {y}_{g}^{2} )$ |
| POWER | | | | |
| NOTIFICATION PARAMETERS OF SCHEDULING AFTER | Wr ∈ [symbol] ^{N}^{ₜ}^{× N}^{ᵤ} | $\frac{{b}_{r}}{{a}_{r}} , \frac{{c}_{r}}{{a}_{r}} ∈$ | ROTATION ANGLE TO x′ AXIS φₙ | N/A |
| REDUCING PARAMETER | | | | |
| NUMBER OF REAL | 2NₜNᵤ | 2N_{BS} | N_{BS} | 0 |
| PARAMETERS PER | | | | |
| RADIO RESOURCE | | | | |

Due to the degrees of freedom of the array antenna 130, Nu+N_{BS}≤Nt. In addition, NtNu≥Nu (Nu+N_{BS})>NuN_{BS}≥N_{BS}. Therefore, since NtNu>N_{BS} holds, the interference estimation methods A, B and C using the parameter-reduced interference model generally have fewer parameters than the exact method. For example, when Nt=196, Nu=12 and N_{BS}=6, each of the number of parameters in the interference estimation methods A and B combining the parameter reduction is approximately 1/400 and 1/800 of the number of parameters in the exact method.

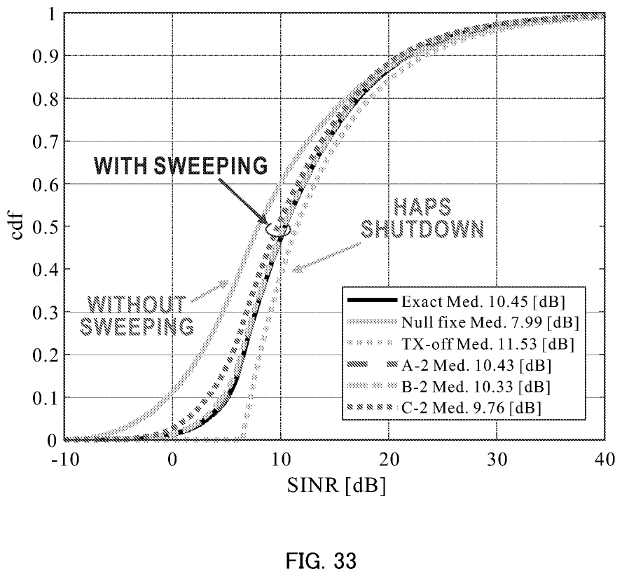

FIG. 33 is an illustration showing an example of a result of computer simulation in which the improvement effect of SINR in a terrestrial cell is calculated in the cases that the user scheduling is performed by estimating the interference power by the exact method and the interference estimation methods A, B and C that combine with the parameter reduction, according to the embodiment. FIG. 33 is calculation results of the SINR cumulative distribution when the horizontal distance D between the HAPS (upper airspace PF) 10 and the terrestrial base station 30 is 40 km and there are two candidate points for the null to be swept per terrestrial cell. As shown in FIG. 33, by applying the greedy method-like algorithms of the user scheduling methods A-2, B-2 and C-2, in which the above-mentioned interference estimation methods A, B and C are respectively combined with the reduced number of parameters, to null sweeping, it is possible to reduce the amount of control parameter information notified from the HAPS (upper airspace PF) 10 to the terrestrial base station 30, an improvement effect of SINR can be observed compared to the case without a null sweeping.

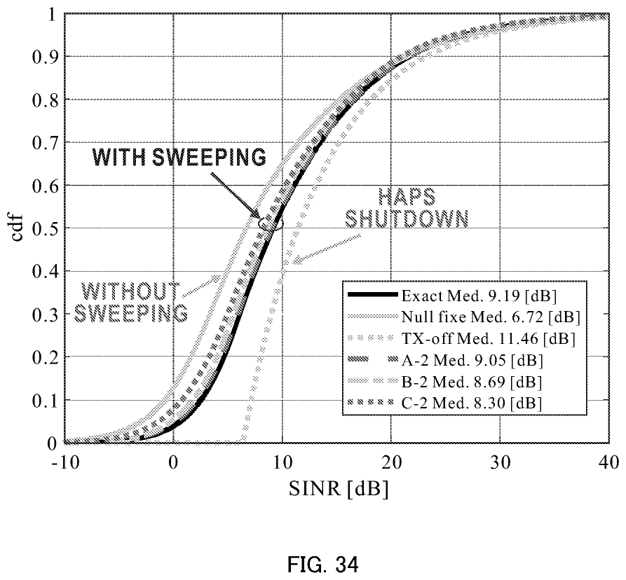

FIG. 34 is an illustration showing another example of a result of computer simulation in which the improvement effect of SINR in the terrestrial cell is calculated in the cases that the user scheduling is performed by estimating the interference power by the exact method and the interference estimation methods A, B and C that combine with parameter reduction, according to the embodiment. FIG. 34 is a calculation result of the SINR cumulative distribution when the horizontal distance D between the HAPS (upper airspace PF) 10 and the terrestrial base station 30 is 20 km and there are two candidate points for the null to be swept per terrestrial cell. As shown in FIG. 34, even when the distance between the HAPS (upper airspace PF) 10 and the terrestrial base station 30 is short, by applying the greedy method-like algorithm of user scheduling methods A-2, B-2, and C-2, in which the above-mentioned interference estimation methods A, B, and C are respectively combined with the reduced number of parameters, to null sweeping, it is possible to reduce the amount of control parameter information notified from the HAPS (upper airspace PF) 10 to the terrestrial base station 30, an improvement effect of SINR can be observed compared to the case without a null sweeping.

### [Overall System Configuration and Processing Flow]

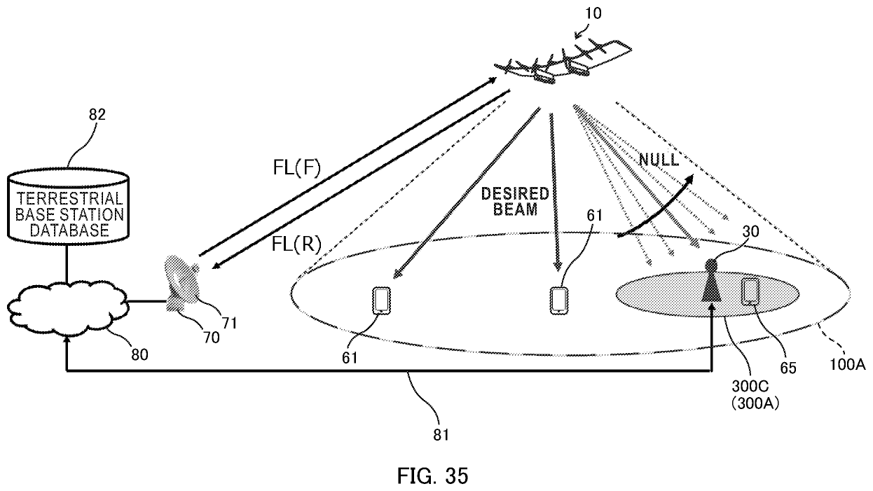

FIG. 35 is an illustration showing an example of the overall configuration of a system having a terrestrial-base station database 82, according to the embodiment. It is noted that in FIG. 35, the same parts as those in FIG. 1 described above are denoted by the same reference numerals and their explanations are omitted. In addition, although FIG. 35 shows a case where the relay communication station 110 mounted on the HAPS 10 is a relay communication station of base station apparatus type having a base station apparatus, the relay communication station 110 mounted on the HAPS 10 may also be a relay communication station of repeater type. In this case, the system is provided with the relay communication station 110 mounted on the HAPS 10 and the base station apparatus mounted on the feeder station (gateway station) 70 on land, etc., and the wide-area cell base station (HAPS base station) includes the relay communication station of repeater type mounted on the HAPS 10 and the terrestrial base station apparatus on land.

In FIG. 35, the HAPS (upper airspace PF) 10 can notify the terrestrial base station 30 via the feeder station (gateway station) 70, the mobile communication network 80 and a backhaul line 81. In addition, the HAPS 10 can access the terrestrial-base station database 82 via the feeder station (gateway station) 70 and the mobile communication network 80 to obtain information on the terrestrial base station 30. The terrestrial base station 30 can notify the HAPS 10 of the switching information on UL and DL in the terrestrial cell 300C, via the backhaul line 81, the mobile communication network 80 and the feeder station (gateway station) 70.

The HAPS 10 and the terrestrial base station 30 share, for example, information I1 (hereinafter referred to as “notification information”) that is periodically notified from the HAPS 10 to the terrestrial base station 30, and information 12 (hereinafter referred to as “DB information”) that is stored in the terrestrial-base station database 82.

The notification information I1 depends on the user scheduling algorithm of the terrestrial base station 30, and is, for example, the following kinds of information (I1-1) to (I1-3).
(I1-1) Location information and three-dimensional rotation information on the airframe of HAPS 10 at time t.
(I1-2) Number for identifying a null applied to the radio resource (time-frequency resource) r.
(I1-3) Information necessary for estimating an interference power from the HAPS 10 in the radio resource (time/frequency resource) r.

The information (I1-3) required for estimating the interference power from the HAPS 10 is, for example, the following kinds of information (I1-3-1) to (I1-3-4).
(I1-3-1) Precoding weight matrix (transmission weight matrix) applied to the radio resource (time-frequency resource) r or the control parameter information on the interference estimation method mentioned above.
(I1-3-2) Precoding weight matrix (transmission weight matrix) obtained by statistically processing the foregoing information (I1-3-1) or the control parameter information on the interference estimation method mentioned above, in order to reduce the amount of information to be notified.
(I1-3-3) Information sufficient to reconstruct the shape of the null formed in the radio resource (time/frequency resource) r in two or three dimensions at the terrestrial base station side.
(I1-3-4) Information obtained by statistically processing the above information (I1-3-3), in order to reduce the amount of information to be notified.

The information I2 stored in the terrestrial-base station database 82 is information referenced from the HAPS 10, and is, for example, the following kinds of information (I2-1) to (I2-3).
(I2-1) Coordinates of the terrestrial base station 30.
(I2-2) Cell radius of the terrestrial base station 30.
(I2-1) Geographic distribution of users connected to the terrestrial base station 30, (which changes over time).

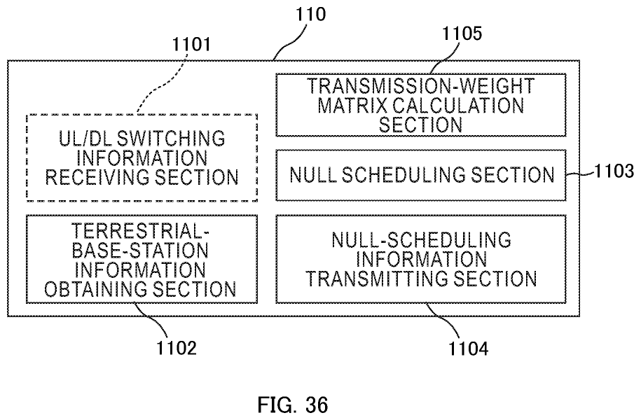

FIG. 36 is a block diagram showing an example of the main configuration of the relay communication station of base station apparatus type 110 mounted on the HAPS 10 in the system of FIG. 35. FIG. 36 is a configuration example when operating in the TDD communication method. In FIG. 36, the relay communication station 110 is provided with a UL/DL switching information receiving section 1101, an information obtaining section 1102 of the terrestrial base station, a null scheduling section 1103, and a null-scheduling information transmitting section 1104. The UL/DL switching information receiving section 1101 receives UL/DL switching information from each terrestrial base station 30 via the feeder link FL. The information obtaining section 1102 of the terrestrial base station accesses the terrestrial-base station database 82 via the feeder link FL and obtains information regarding the terrestrial base stations located in the service area 100A (HAPS cell 100C). The null scheduling section 1103 determines the allocation (scheduling) of nulls on time axis and frequency axis for each terrestrial base station, based on the UL/DL switching information received from each terrestrial base station 30 and the information on the terrestrial base station obtained from the terrestrial-base station database 82. The null-scheduling information transmitting section 1104 notifies each terrestrial base station 30 of the null scheduling information including the information on the transmission weight matrix, via the feeder link FL and the mobile communication network (network) 80. The transmission-weight matrix calculation section 1105 calculates a transmission weight matrix to be applied to the array antenna 130, which is used for estimating the interference power by the above-mentioned exact method.

It is noted that, in FIG. 36, when operating in the FDD communication method, the UL/DL switching information receiving section 1101 is not necessary.

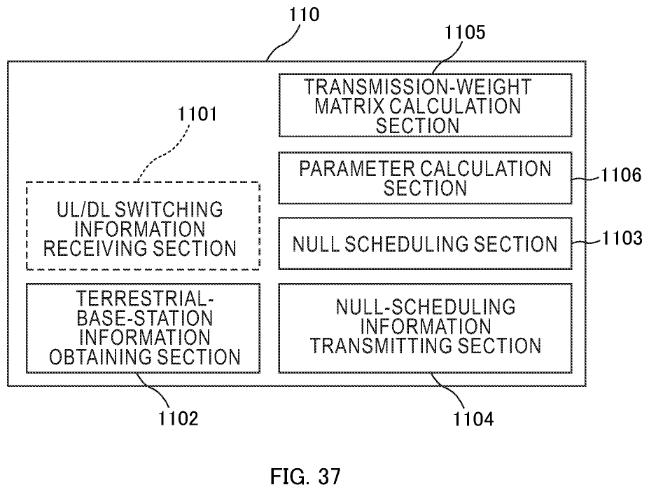

FIG. 37 is a block diagram showing another example of the main configuration of the relay communication station of base station apparatus type 110 mounted on the HAPS 10 in the system of FIG. 35. FIG. 37 is a configuration example when operating in the TDD communication method. It is noted that, in FIG. 37, parts common to those in FIG. 36 described above are given the same reference numerals and their explanations are omitted.

In the relay communication station 110 of FIG. 37, the transmission-weight matrix calculation section 1105 calculates a transmission weight matrix to be applied to the array antenna 130. A parameter calculation section 1106 calculates parameters such as coefficients of the above-mentioned calculation formula used for estimating the interference power by the interference estimation method A, B or C according to the above-mentioned interference model. The null-scheduling information transmitting section 1104 notifies each terrestrial base station 30 of the null scheduling information including information on the parameters used for estimating the interference power, via the feeder link FL and the mobile communication network (network) 80.

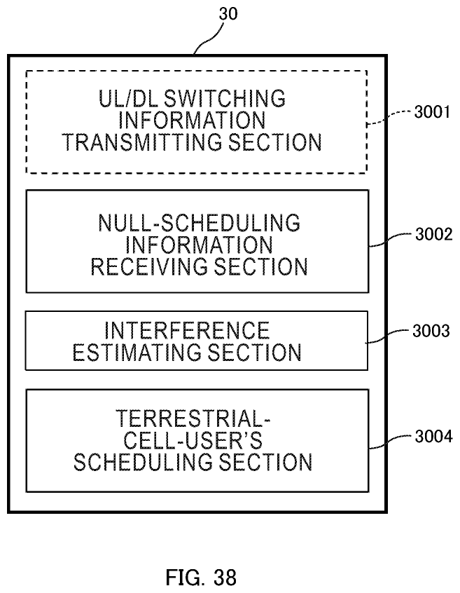

FIG. 38 is a block diagram showing an example of the main configuration of the terrestrial base station 30 in the communication system of FIG. 35. FIG. 38 is a configuration example when operating in the TDD communication method. In FIG. 38, the terrestrial base station 30 is provided with a UL/DL switching information transmitting section 3001, a null-scheduling information receiving section 3002, an interference estimating section 3003, and a terrestrial cell user's scheduling section 3004. The UL/DL switching information transmitting section 3001 notifies the HAPS 10 of the UL/DL switching information in the terrestrial cell of its own cell. The null-scheduling information receiving section 3002 receives the null scheduling information from the HAPS 10, which includes information on the transmission weight matrix or parameters to be used for estimating the interference power for the above-mentioned user scheduling, regarding the terrestrial base station 30 itself. The interference estimation section 3003 estimates an interference from the HAPS 10 to the user (UE 65) located in its own cell, based on the null scheduling information. The terrestrial cell user's scheduling section 3004 determines a user allocation (scheduling) on time axis and on frequency axis.

It is noted that, in FIG. 38, when operating in the FDD communication method, the UL/DL switching information transmitting section 3001 is not necessary.

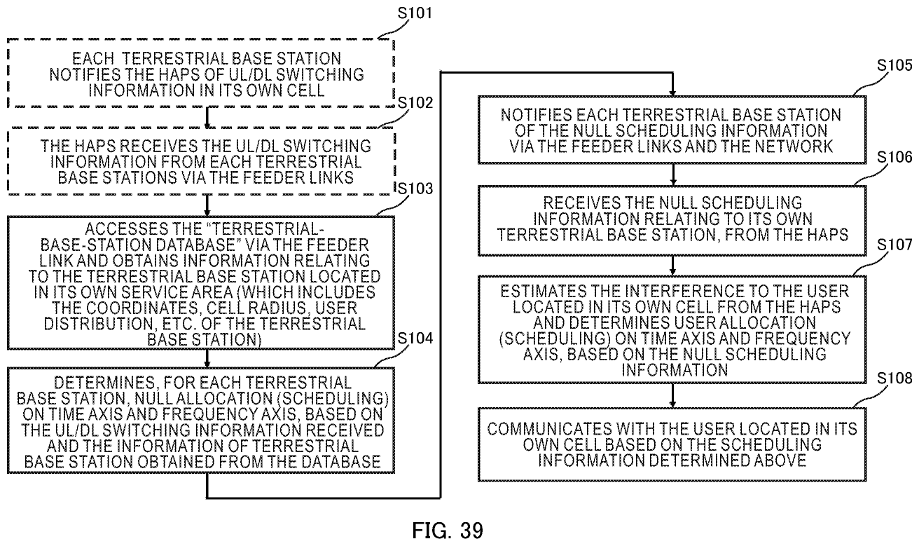

FIG. 39 is a flowchart showing an example of a processing flow in the HAPS base station and the terrestrial-cell base station when performing a beamforming control and a service link communication involving null formation in the communication system, according to the embodiment. FIG. 39 is an example of a processing flow when operating in the TDD communication method.

In FIG. 39, each terrestrial base station 30 notifies the HAPS 10 of the UL/DL switching information in its own cell (S101).

Next, the HAPS 10 receives the UL/DL switching information from each terrestrial base station 30 via the feeder link FL (S102).

Next, the HAPS 10 accesses the terrestrial-base station database 82 via the feeder link FL, and obtains the information on the terrestrial base stations 30 located in the service area 100A (HAPS cell 100C) (S103). The information to be obtained includes the coordinates of the terrestrial base station 30, the cell radius, the user distribution, and so on.

Next, the HAPS 10 determines, for each terrestrial base station, a null allocation (scheduling) on time axis and frequency axis and the information on the transmission weight matrix or parameters used for estimating the interference power to be used for the above-mentioned user scheduling at the terrestrial base station 30, based on the UL/DL switching information received from each terrestrial base station 30 and the information on the terrestrial base station 30 obtained from the terrestrial-base station database 82 (S104).

Next, the HAPS 10 notifies each of the terrestrial base stations 30 of the null scheduling information including the information on the transmission weight matrix or parameters used for estimating the interference power to be used for the above-described user scheduling in the terrestrial base station 30, via the feeder link FL and the mobile communication network (network) 80 (S105).

Next, the terrestrial base station 30 receives the null scheduling information from the HAPS 10, which includes the information on the transmission weight matrix or parameters to be used for estimating the interference power to be used for the above-described user scheduling at the station itself, regarding the terrestrial base station 30 itself (S106).

Next, the terrestrial base station 30 estimates the interference from the HAPS 10 to the user (UE 65) located in its own cell and determines a user allocation (scheduling) on time axis and frequency axis, based on the null scheduling information including the information on the transmission weight matrix or parameter described above (S107).

Next, the terrestrial base station 30 communicates with the user (UE 65) located in its own cell, based on the scheduling information determined in step S107 (S108).

It is noted that, in FIG. 39, when operating in the FDD communication method, the steps for transmitting and receiving the UL/DL switching information (S101, S102) are not necessary.

As described above, according to the present embodiment, in the case that the terrestrial cell formed by the antenna of the terrestrial base station using the same frequency band is located in the cell 100C formed from HAPS 10 in the upper airspace toward the ground or sea surface, it is capable of suppressing the interference from the HAPS 10 to the terrestrial cell (terrestrial base station 30 and the UE 65 connected to the terrestrial base station).

Furthermore, according to the present embodiment, it is possible to reduce the residual interference when the null of the directional beam is formed from the relay communication station 110 mounted on the HAPS 10 in the upper airspace toward the coverage area of the terrestrial base station 30.

In particular, according to the present embodiment, it is possible to reduce the amount of control parameter information notified from the HAPS (upper airspace PF) 10 to the terrestrial base station 30, and improve the SINR in the entire terrestrial cell compared to the case without a null sweeping.

The present invention can provide a system capable of reducing the residual interference when forming the null of the directional beam from the relay communication station 110 mounted on the HAPS 10 in the upper airspace toward the coverage area of the terrestrial base station 30, so it is possible to contribute to achieving Goal 9 of the Sustainable Development Goals (SDGs), which is to “Create a foundation for industry and technological innovation”.

It is noted that, the process steps and configuration elements of the relay communication station of the communication relay apparatus such as the HAPS 10, etc., the feeder station, the gateway station, the management apparatus, the surveillance apparatus, the remote control apparatus, the server, the terminal apparatus (UE: user apparatus, mobile station, communication terminal), the base station and the base station apparatus described in the present description can be implemented with various means. For example, these process steps and configuration elements may be implemented with hardware, firmware, software, or a combination thereof.

With respect to hardware implementation, means such as processing units or the like used for establishing the foregoing steps and configuration elements in entities (for example, relay communication station, feeder station, gateway station, base station, base station apparatus, relay-communication station apparatus, terminal apparatus (UE: user apparatus, mobile station, communication terminal), management apparatus, monitoring apparatus, remote control apparatus, server, hard disk drive apparatus, or optical disk drive apparatus) may be implemented in one or more of an application-specific IC (ASIC), a digital signal processor (DSP), a digital signal processing apparatus (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing units or the like used for establishing the foregoing configuration elements may be implemented with a program (for example, code such as procedure, function, module, instruction, etc.) for performing a function described in the present specification. In general, any computer/processor readable medium of materializing the code of firmware and/or software may be used for implementation of means such as processing units and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage unit, or the like. The code may be executed by one or more of computers and processors, and a certain aspect of functionalities described in the present specification may by executed by a computer or processor.

The medium may be a non-transitory recording medium. Further, the code of the program may be executable by being read by a computer, a processor, or another device or an apparatus machine, and the format is not limited to a specific format. For example, the code of the program may be any of a source code, an object code, and a binary code, and may be a mixture of two or more of those codes.

The description of embodiments disclosed in the present specification is provided so that the present disclosures can be produced or used by those skilled in the art. Various modifications of the present disclosures are readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: HAPS
30: terrestrial base station (terrestrial-cell base station)
40: radio resource
50A to 50C: interference model
61: UE (terminal apparatus) connected to wide-area cell
65: UE (terminal apparatus) connected to terrestrial cell
70: feeder station (GW station)
71: antenna
80: mobile communication network (network)
81: backhaul line
82: terrestrial-base station database
100A: service area of wide-area cell
100AN: null area
100B: beam
100C: HAPS cell (3D cell)
100F: footprint
100N: null
110: relay communication station
130: array antenna (service link antenna)
130a: antenna element
300C: terrestrial cell
300A: service area of terrestrial cell

1. (canceled)

2. A system comprising a wide-area cell base station that forms a wide-area cell toward a ground or sea surface from a service link antenna of a relay communication station mounted on a flying body or floating body located in an upper airspace, and one or plural terrestrial-cell base stations that form a terrestrial cell from an antenna disposed on land or at sea,
wherein the wide-area cell base station and the one or plural terrestrial-cell base stations perform service-link communications in a same frequency band using radio frames that are time-synchronized with each other,
wherein the wide-area cell base station:
obtains information regarding the terrestrial-cell base station located in the wide-area cell;
determines a null scheduling regarding a null allocation on time axis and frequency axis based on the information regarding the terrestrial-cell base station; and
transmits information on the null scheduling to the terrestrial-cell base station, and
wherein the terrestrial-cell base station:
receives the information on the null scheduling from the wide-area cell base station;
determines a user scheduling regarding an allocation of a terminal apparatus of a user on time axis and frequency axis based on the information on the null scheduling; and
performs a communication with a terminal apparatus of a user located in its own cell, based on information on the user scheduling,
wherein the information on the null scheduling includes information on a transmission weight matrix Wr to be applied to an antenna of the wide-area cell base station when forming the null,
wherein the terrestrial-cell base station:
estimates a propagation path response hg between the antenna of the wide-area cell base station and a terminal apparatus of a user g located in its own cell; and
estimates an interference power I(r, g) from the wide-area cell to the terminal apparatus of the user g located in its own cell for a radio resource r using a following equation (1) based on the transmission weight matrix Wr and an estimation result of the propagation path response hg.
$$I ( r , g ) = {‖ {h}_{g} {W}_{r} ‖}^{2} \qquad ( 1 )$$

3. The system according to claim 2,
wherein the information on the transmission weight matrix Wr included in the information on the null scheduling is information obtained by statistically processing plural elements of the transmission weight matrices Wr.

4. A system comprising a wide-area cell base station that forms a wide-area cell toward a ground or sea surface from a service link antenna of a relay communication station mounted on a flying body or floating body located in an upper airspace, and one or plural terrestrial-cell base stations that form a terrestrial cell from an antenna disposed on land or at sea,
wherein the wide-area cell base station and the one or plural terrestrial-cell base stations perform service-link communications in a same frequency band using radio frames that are time-synchronized with each other,
wherein the wide-area cell base station:
obtains information regarding the terrestrial-cell base station located in the wide-area cell;
determines a null scheduling regarding a null allocation on time axis and frequency axis based on the information regarding the terrestrial-cell base station; and
transmits information on the null scheduling to the terrestrial-cell base station,
wherein the terrestrial-cell base station:
receives the information on the null scheduling from the wide-area cell base station;
determines a user scheduling regarding an allocation of a terminal apparatus of a user on time axis and frequency axis based on the information on the null scheduling; and
performs a communication with a terminal apparatus of a user located in its own cell, based on information on the user scheduling,
wherein the information on the null scheduling includes information on a parameter for interference estimation that is determined based on an interference model of modeling a spatial distribution of interference power from the wide-area cell to a terminal apparatus of a user located in the terrestrial cell, the interference model using a position corresponding to a null point formed by the wide-area cell base station as an origin, and
wherein the terrestrial-cell base station estimates an interference power I (r, g) from the wide-area cell to a terminal apparatus of a user g located in its own cell for a radio resource r, based on the information on the parameter for interference estimation.

5. The system according to claim 4,
wherein the information on the parameter for interference estimation included in the information on the null scheduling is information obtained by statistically processing plural values of the parameters for interference estimation.

6. The system according to claim 4,
wherein the interference model is an interference model in which, in an orthogonal coordinate system (x, y, z) with a position corresponding to the null point as the origin, the interference power is set to the z direction and a distribution of the interference power at positions on an x-y plane is approximated by an elliptical paraboloid,
wherein the information on the parameter for interference estimation is values of coefficients aᵣ, bᵣ and cᵣ in a following equation (2) defined in the orthogonal coordinate system (x, y, z), and
wherein the terrestrial-cell base station estimates an interference power I_{modelA} (r, g) from the wide-area cell to a terminal apparatus of a user g located at a coordinate position (x_{g}, y_{g}) of its own cell for each radio resource r, based on the following equation (2) and the values of the coefficients aᵣ, bᵣ and cᵣ.
$${I}_{model A} ( r , g ) = {a}_{r} {x}_{g}^{2} + {b}_{r} {x}_{g} {y}_{g} + {c}_{r} {y}_{g}^{2} \qquad ( 2 )$$

7. The system according to claim 6,
wherein the information on the parameter for interference estimation is a value obtained by normalizing two coefficients by another coefficient among the coefficients aᵣ, bᵣ and cᵣ, and
wherein the terrestrial-cell base station estimates an interference power from the wide-area cell to a terminal apparatus of a user g located at a coordinate position (x_{g}, y_{g}) of the its own cell for each radio resource r, based on the value of the coefficient.

8. The system according to claim 4,
wherein the interference model is an interference model in which, in the orthogonal coordinate system (x, y, z) with a position corresponding to the null point as the origin, the interference power is set to the z direction, a distribution of the interference power at positions on an x-y plane is approximated by an elliptical paraboloid, and the orthogonal coordinates are rotated by a rotation angle or so that the x-axis coincides with the minor axis of an ellipse having equal power when the elliptical paraboloid is projected onto the x-y plane,
wherein the information on the parameter for interference estimation is a value of a coefficient aᵣ′ in a following equation (3) defined in the rotated orthogonal coordinate system (x′, y′, z), and
wherein the terrestrial-cell base station estimates an interference power I_{modelB} (r, g) from the wide-area cell to a terminal apparatus of a user g located at a coordinate position (x_{g}′, y_{g}′) of its own cell for each radio resource r, based on the following equation (3) and the value of the coefficient aᵣ′.
$${I}_{model B} ( r , g ) = {a}_{r}^{′} {x}_{g}^{′2} = {{a}_{r}^{′} ( cos ( {ϕ}_{r} ) {x}_{g} - sin ( {ϕ}_{r} ) {y}_{g} )}^{2} \qquad ( 3 )$$

9. The system according to claim 8,
wherein the terrestrial-cell base station calculates a normalized value of the interference power I_{modelB} (r, g) as an estimated value of interference power from the wide-area cell to a terminal apparatus of a user g located at a coordinate position (x_{g}′, y_{g}′) of its own cell for each radio resource r, based on a following equation (4) obtained by dividing the equation (3) by the coefficient aᵣ′.
$${\hat{I}}_{model B} ( r , g ) = {x}_{g}^{′2} = {( cos ( {ϕ}_{r} ) {x}_{g} - sin ( {ϕ}_{r} ) {y}_{g} )}^{2} \qquad ( 4 )$$

10. The system according to claim 4,
wherein the interference model is an interference model in which, in the orthogonal coordinate system (x, y, z) with a position corresponding to the null point as the origin, the interference power is set to the z direction, and a distribution of the interference power at positions on an x-y plane is approximated by a paraboloid of revolution,
wherein the information on the parameter for interference estimation is a value of a coefficient aᵣ″ in a following equation (5) defined in the orthogonal coordinate system (x, y, z), and
wherein the terrestrial-cell base station estimates an interference power I_{modelC} (r, g) from the wide-area cell to a terminal apparatus of user g located at a coordinate position (x_{g}, y_{g}) of its own cell for each radio resource r, based on the following equation (5) and the value of the coefficient aᵣ″.
$${I}_{model C} ( r , g ) = {a}_{r}^{′′} ( {x}_{g}^{2} + {y}_{g}^{2} ) \qquad ( 5 )$$

11. The system according to claim 10,
wherein the terrestrial-cell base station calculates a normalized value of the interference power I_{modelC} (r, g) as an estimate of interference power from the wide-area cell to a terminal apparatus of a user g located at a coordinate position (x_{g}, y_{g}) of its own cell for each radio resource r, based on a following equation (6) obtained by dividing the equation (5) by the coefficient aᵣ″.
$${\hat{I}}_{model C} ( r , g ) = {x}_{g}^{2} + {y}_{g}^{2} \qquad ( 6 )$$

12. The system according to any one of claim 2,
wherein, in the user scheduling, the terrestrial-cell base station performs:
an initialization process including setting a first set of user numbers g of terminal apparatuses of plural (Nu) unallocated users and setting a second set of plural (Nr=rₘₐₓ) radio resources to be processed by a greedy method in order of resource number r; and
a process of setting the r-th resource number r of the second set as a resource number r to be allocated, in order of a first (r=1) to an Nr-th (r=rₘₐₓ) resource number r of the second set, calculating an interference power when the radio resource of resource number r is allocated, allocating a user number g of a terminal apparatus of user for which the calculated value of the interference power or a metric value for determination corresponding to the calculated value of the interference power is smallest, as a user number gr to be allocated to the resource number r, and removing the user number gr for which the allocation is confirmed, from the first set.

13. The system according to claim 3,
wherein, in the user scheduling, the terrestrial-cell base station performs:
an initialization process including setting a first set of user numbers g of terminal apparatuses of plural (Nu) unallocated users and setting a second set of plural (Nr=rₘₐₓ) radio resources to be processed by a greedy method in order of resource number r; and
a process of setting the r-th resource number r of the second set as a resource number r to be allocated, in order of a first (r=1) to an Nr-th (r=rₘₐₓ) resource number r of the second set, calculating an interference power when the radio resource of resource number r is allocated, allocating a user number g of a terminal apparatus of user for which the calculated value of the interference power or a metric value for determination corresponding to the calculated value of the interference power is smallest, as a user number gr to be allocated to from the first set.

14. The system according to claim 4,
wherein, in the user scheduling, the terrestrial-cell base station performs:
an initialization process including setting a first set of user numbers g of terminal apparatuses of plural (Nu) unallocated users and setting a second set of plural (Nr=rₘₐₓ) radio resources to be processed by a greedy method in order of resource number r; and
a process of setting the r-th resource number r of the second set as a resource number r to be allocated, in order of a first (r=1) to an Nr-th (r=rₘₐₓ) resource number r of the second set, calculating an interference power when the radio resource of resource number r is allocated, allocating a user number g of a terminal apparatus of user for which the calculated value of the interference power or a metric value for determination corresponding to the calculated value of the interference power is smallest, as a user number gr to be allocated to the resource number r, and removing the user number gr for which the allocation is confirmed, from the first set.

15. The system according to claim 5,
wherein, in the user scheduling, the terrestrial-cell base station performs:
an initialization process including setting a first set of user numbers g of terminal apparatuses of plural (Nu) unallocated users and setting a second set of plural (Nr=rₘₐₓ) radio resources to be processed by a greedy method in order of resource number r; and
a process of setting the r-th resource number r of the second set as a resource number r to be allocated, in order of a first (r=1) to an Nr-th (r=rₘₐₓ) resource number r of the second set, calculating an interference power when the radio resource of resource number r is allocated, allocating a user number g of a terminal apparatus of user for which the calculated value of the interference power or a metric value for determination corresponding to the calculated value of the interference power is smallest, as a user number gr to be allocated to from the first set.

16. The system according to claim 6,
wherein, in the user scheduling, the terrestrial-cell base station performs:
an initialization process including setting a first set of user numbers g of terminal apparatuses of plural (Nu) unallocated users and setting a second set of plural (Nr=rₘₐₓ) radio resources to be processed by a greedy method in order of resource number r; and
a process of setting the r-th resource number r of the second set as a resource number r to be allocated, in order of a first (r=1) to an Nr-th (r=rₘₐₓ) resource number r of the second set, calculating an interference power when the radio resource of resource number r is allocated, allocating a user number g of a terminal apparatus of user for which the calculated value of the interference power or a metric value for determination corresponding to the calculated value of the interference power is smallest, as a user number gr to be allocated to the resource number r, and removing the user number gr for which the allocation is confirmed, from the first set.

17. The system according to claim 7,
wherein, in the user scheduling, the terrestrial-cell base station performs:
an initialization process including setting a first set of user numbers g of terminal apparatuses of plural (Nu) unallocated users and setting a second set of plural (Nr=rₘₐₓ) radio resources to be processed by a greedy method in order of resource number r; and
a process of setting the r-th resource number r of the second set as a resource number r to be allocated, in order of a first (r=1) to an Nr-th (r=rₘₐₓ) resource number r of the second set, calculating an interference power when the radio resource of resource number r is allocated, allocating a user number g of a terminal apparatus of user for which the calculated value of the interference power or a metric value for determination corresponding to the calculated value of the interference power is smallest, as a user number gr to be allocated to from the first set.

18. The system according to claim 8,
wherein, in the user scheduling, the terrestrial-cell base station performs:
an initialization process including setting a first set of user numbers g of terminal apparatuses of plural (Nu) unallocated users and setting a second set of plural (Nr=rₘₐₓ) radio resources to be processed by a greedy method in order of resource number r; and
a process of setting the r-th resource number r of the second set as a resource number r to be allocated, in order of a first (r=1) to an Nr-th (r=rₘₐₓ) resource number r of the second set, calculating an interference power when the radio resource of resource number r is allocated, allocating a user number g of a terminal apparatus of user for which the calculated value of the interference power or a metric value for determination corresponding to the calculated value of the interference power is smallest, as a user number gr to be allocated to the resource number r, and removing the user number gr for which the allocation is confirmed, from the first set.

19. The system according to claim 9,
wherein, in the user scheduling, the terrestrial-cell base station performs:
an initialization process including setting a first set of user numbers g of terminal apparatuses of plural (Nu) unallocated users and setting a second set of plural (Nr=rₘₐₓ) radio resources to be processed by a greedy method in order of resource number r; and
a process of setting the r-th resource number r of the second set as a resource number r to be allocated, in order of a first (r=1) to an Nr-th (r=rₘₐₓ) resource number r of the second set, calculating an interference power when the radio resource of resource number r is allocated, allocating a user number g of a terminal apparatus of user for which the calculated value of the interference power or a metric value for determination corresponding to the calculated value of the interference power is smallest, as a user number gr to be allocated to from the first set.

20. The system according to claim 10,
wherein, in the user scheduling, the terrestrial-cell base station performs:
an initialization process including setting a first set of user numbers g of terminal apparatuses of plural (Nu) unallocated users and setting a second set of plural (Nr=rₘₐₓ) radio resources to be processed by a greedy method in order of resource number r; and
a process of setting the r-th resource number r of the second set as a resource number r to be allocated, in order of a first (r=1) to an Nr-th (r=rₘₐₓ) resource number r of the second set, calculating an interference power when the radio resource of resource number r is allocated, allocating a user number g of a terminal apparatus of user for which the calculated value of the interference power or a metric value for determination corresponding to the calculated value of the interference power is smallest, as a user number gr to be allocated to the resource number r, and removing the user number gr for which the allocation is confirmed, from the first set.

21. The system according to claim 11,
wherein, in the user scheduling, the terrestrial-cell base station performs:
an initialization process including setting a first set of user numbers g of terminal apparatuses of plural (Nu) unallocated users and setting a second set of plural (Nr=rₘₐₓ) radio resources to be processed by a greedy method in order of resource number r; and
a process of setting the r-th resource number r of the second set as a resource number r to be allocated, in order of a first (r=1) to an Nr-th (r=rₘₐₓ) resource number r of the second set, calculating an interference power when the radio resource of resource number r is allocated, allocating a user number g of a terminal apparatus of user for which the calculated value of the interference power or a metric value for determination corresponding to the calculated value of the interference power is smallest, as a user number gr to be allocated to from the first set.
